(19) United States
(12) Patent Application Publication
(10) Pub. No.: US 2009/0214408 A1
(43) Pub. Date: Aug. 27, 2009

(54) PREPARATION AND USE OF CATIONIC HALIDES, SEQUESTRATION OF CARBON DIOXIDE

(75) Inventors: Stephen W.M. Blake, New South Wales (AU); Christopher Cuff, Kelso Queensland (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: GREENSOLS AUSTRALIA Pty Ltd, North Curl Curl (AU)

(21) Appl. No.: 11/994,310

(22) PCT Filed: Jul. 5, 2006
(86) PCT No.: PCT/AU06/00948

§ 371 Date: Jun. 6, 2008

(30) Foreign Application Priority Data
Jul. 5, 2005 (AU) 2005903567

(51) Int. Cl. B01D 53/62

(52) U.S. Cl. 423/232; 423/220; 423/234; 422/177

(57) ABSTRACT

A process is described for sequestering carbon dioxide. In the process, a carbonate, oxide or hydroxide of a divalent cation is reacted with the carbon dioxide and water and/or with a species resulting from the dissolution of the carbon dioxide in water, to form a hydrogen carbonate of the divalent cation. The carbonate, oxide or hydroxide of the divalent cation has a low solubility in water. The divalent cation of the hydrogen carbonate of the divalent cation thus formed is exchanged for a monovalent cation using an ion exchange medium, to produce a solution of a hydrogen carbonate of the monovalent cation.

### FIELD OF THE INVENTION

The present invention relates to a process for the preparation of cationic halide compounds, to the use of the compounds thus formed for sequestration of carbon dioxide, to a process for the production of an alkaline earth metal halide, to a process for the sequestration of atmospheric carbon dioxide, and to processes for the recovery of calcite, magnesite, dolomite and various other compounds and substances from sea water.

### BACKGROUND OF THE INVENTION

Excess atmospheric CO₂ created by burning of fossil fuels is believed to be a major cause of global warming. To counter this, industries directed towards the uptake and sequestration of atmospheric CO₂ are being promoted by a system of carbon credits which can be traded with CO₂-producing industries.

A principal form of carbon sequestration, rewardable by carbon credits, is the planting of biomass such as tree plantations. However, carbon sequestration by this method is relatively short term by geologic and climatic time frames as the sequestered carbon begins to release again once the biomass is harvested.

U.S. Pat. No. 6,190,301 describes a process for the disposal of gaseous carbon dioxide in which the carbon dioxide is solidified and then embedded in open water floor sediment, wherein the depth and temperature of the sea water is selected such as to transform the carbon dioxide to a clathrate which embeds itself in sedimentary formations. U.S. Pat. No. 6,235,091, U.S. Pat. No. 5,397,553 and U.S. Pat. No. 6,106,595 describe other processes in which clathrates are used to store carbon dioxide in the sea.

U.S. Pat. No. 6,500,216 describes a process for desalinating sea water and for the recovery of sodium chloride therefrom. However, it does not disclose a process for the sequestration of carbon dioxide.

### OBJECTS OF THE INVENTION

The present invention aims to provide an inorganic process which releases little or no CO₂ and which will result in the production of cationic halides suitable for use in the longer-term sequestration of atmospheric CO₂.

### SUMMARY OF THE INVENTION

### Process for the Production of Divalent Cationic Halides

In accordance with a first aspect, the present invention provides a process for the production of a divalent cationic halide, including the steps of:

(a) reacting a divalent cationic carbonate, oxide or hydroxide with CO₂ (carbon dioxide) and water and/or with a species resulting from the dissolution of CO₂ in water, to form a divalent cationic hydrogen carbonate or bicarbonate;

(b) exchanging the cation of the divalent cationic hydrogen carbonate or bicarbonate thus formed, using an ion exchange medium, for a monovalent cation to produce a monovalent cationic hydrogen carbonate; and

(c) regenerating the ion exchange medium with a monovalent cationic halide to produce said divalent cationic halide,

wherein said divalent cationic carbonate has a low solubility in water. The low solubility may be as defined by its solubility product (Ksp) value (see Table 4 below).

The divalent cationic carbonate may be a carbonate mineral solid. The carbonate mineral solid may be defined in terms of its low solubility product (Ksp values), its low molar/molal concentration in both fresh and marine waters, and the behaviour of its solubility as a function of temperature. For CaCO₃, solubilities generally decrease over the temperature range 0-80° C. rather than the more normal behaviour of increasing. It will be understood that in the context of the present invention, the divalent cationic carbonate may be a mixture or blend of two or more divalent cationic carbonates, or may be a mixed divalent cationic carbonate (i.e. a cationic carbonate comprising two or more cations). Accordingly, the divalent cationic hydrogen carbonate or bicarbonate may be a mixture or blend of two or more divalent hydrogen carbonates or bicarbonates, or may be a mixed divalent hydrogen carbonate or bicarbonate, and the divalent cationic halide may be a mixture or blend of two or more divalent cationic halides, or may be a mixed divalent cationic halide. Similarly monovalent cation species described may have a single monovalent cation, or may be blends of species having two or more monovalent cations or may be mixed monovalent cation species. The divalent cationic hydrogen carbonate or bicarbonate may be water soluble. It may be in aqueous solution. The divalent cationic halide may be water soluble. It may be in aqueous solution. The monovalent cationic halide may be water soluble. It may be in aqueous solution.

As used herein, the expression “low solubility” shall be construed as meaning a solubility product, at ambient temperature and pressure, of less than about 1×10⁻⁶, optionally less than about 5×10⁻⁷, 2×10⁻⁷ or 1×10⁻⁷.

As used herein, the expression “sequestration of carbon dioxide” shall be construed as incorporating the permanent or semi-permanent fixation of carbon dioxide in chemical form or physico-chemical form, such as in the carbonate or bicarbonate form.

It will be understood that the term “divalent cationic carbonate” refers to a carbonate of a divalent cation (or of a mixture of divalent cations). Similarly a monovalent cationic carbonate is a carbonate of a monovalent cation (or of a mixture of monovalent cations). Similar definitions pertain to other divalent and monovalent salts.

The divalent cation of the divalent cationic carbonate may be selected from the group consisting of calcium, magnesium, strontium, barium, lead, cadmium, zinc, cobalt, nickel, manganese, iron, the transition metals, and/or any combination thereof.

In a perfectly open system atmospheric CO₂ is in permanent exchange across the freshwater/seawater interface. In this process—

H₂O+CO₂⇄H₂CO₃

H₂CO₃⇄H⁺+HCO₃⁻

HCO₃⁻⇄H⁺CO₃²⁻

Providing that the solution is kept alkaline, precipitation of a range of divalent carbonates occur by reaction of a divalent cation with the carbonate anion:

M²⁺+CO₃²⁻→MCO₃.

These precipitated carbonates generally have low solubilities in both freshwaters and marine waters. They fall generally into two main groups, although some other types (principally involving mixed sized cations) also occur. Mixed size cations are not extensively considered here other than the major dolomite-type structures.

The range of the two main groups of carbonate divalent cation substances are:
1. Rhombohedral (Hexagonal) Carbonate Calcite Group (with Subsidiary Dolomite Group):
Cations generally have a crystallochemical ionic radius of less than approximately 0.1 nm (i.e. 10⁻¹⁰ m=1 Å). The cations and the carbonate minerals include, but are not limited to those shown below.

TABLE 1
CALCITE GROUP (Centro-symmetric)

| | Approximate | Carbonate | Calcite Group/ |
|---|---|---|---|
| Ions | ionic radius | Mineral | Name |
| Ca²⁺ | 0.1 nm | CaCO₃ | Calcite |
| Cd²⁺ | 0.099 nm | CaCO₃ | Otavite |
| Mn²⁺ | 0.092 nm | MnCO₃ | Rhodochrosite |
| Zn²⁺ | 0.080 nm | ZnCO₃ | Smithsonite |
| Fe²⁺ | 0.075 nm | FeCO₃ | Siderite |
| Ni²⁺ | 0.070 nm | NiCO₃ | Gaspeite |
| Co²⁺ | 0.070 nm | CoCO₃ | Sphaerocobaltite |
| Mg²⁺ | 0.068 nm | MgCO₃ | Magnesite |

Intermediate compositions (i.e. mixed cation species) between these end members also occur, as shown in Table 2.

TABLE 2
DOLOMITE GROUP (Non Centro-symmetric)

| Ions | Approximate Radius | Carbonate Mineral | | Dolomite Group/Name |
|---|---|---|---|---|
| Ca²⁺/Mg²⁺ | 0.1 nm/0.068 nm | CaMg(CO₃)₂ | | Dolomite |
| Ca²⁺/Mg²⁺/Fe²⁺ | 0.1 nm/0.68 nm/ | Ca(MgFe)(CO₃)₂ | | Ferroan Dolomite |
| | 0.075 nm | | | |
| Ca²⁺/Mg²⁺/Mn²⁺ | 0.1 nm/0.68 nm/ | Ca(MgFe)(CO₃)₂ | | Manganoan |
| | 0.092 nm | | | Dolomite |
| Ca²⁺/Fe²⁺ | 0.1 nm/0.75 nm | CaFe(CO₃)₂ | | Ferrodolomite |
| | | | | (Ankerite) |
| Ca²⁺/Mn²⁺ | 0.1 nm/0.92 nm | CaMn(CO₃)₂ | | Kutnahorite |
| Complex Fe²⁺ Mn²⁺ | | (CaFeMn) | (CO₃)₂ | Specialised Names |
| Ca²⁺/Mg²⁺ Fe²⁺ | | (MgFeMn) | | |
| Mn²⁺ minerals | | | | |
| Ca²⁺/Zn²⁺ | 0.100/0.080 nm | CaZn (CO₃)₂ | | Minrecordite |
| Ba²⁺/Mg²⁺ | 0.130/0.068 nm | BaMg(CO₃)₂ | | Northesite |
| Ca²⁺/Mg²⁺ | 0.10/0.068 nm | CaMg₃(CO₃)₄ | | Huntite |
| Ba²⁺/Sr²⁺/Ca²⁺/ | 0.130/0.115/ | (BaSrCa) | (CO₃)₂ | Benstonite |
| Mn²⁺/Mg²⁺ | 0.100/0.092/ | (CaMnmg) | | |
| | 0.068 nm | | | |

| | | | |
|---|---|---|---|
| Ca²⁺/Sr²⁺ | 0.1 nm/0.115 nm | CaSr(CO₃)₂ | Specialised |
| Ca²⁺/Ba²⁺ | 0.1 nm/0.130 nm | CaBa(CO₃)₂ | structures. |
| Ba²⁺/Sr²⁺ | 0.130 nm/ | BaSr(CO₃)₂ | Non-hexagonal/ |
| | 0.115 nm | | monoclinic |

2. Orthorhombic Group

Cations generally have a crystallochemical ionic radius of greater than approximately 0.1 nm. The cations include, but are not limited to:

TABLE 3
ORTHORHOMBIC GROUP

| | Approximate | | Carbonate | Calcite |
|---|---|---|---|---|
| Ions | ionic radius | | Mineral | Group/Name |
| Ca²⁺ | 0.1 | nm | CaCO₃ | Aragonite |
| Sr²⁺ | 0.115 | nm | SrCO₃ | Strontianite |
| Pb²⁺ | 0.120 | nm | PbCO₃ | Cerrusite |
| Ba²⁺ | 0.130 | nm | BaCO₃ | Witherite |
| Ba²⁺/Ca²⁺ | 0.130/0.1100 | | (BaSr)CO₃ | Barytocalcite |
| Sr²⁺/Ca²⁺ | 0.115/0.100 | | (SrCa)CO₃ | Strontiocalcite |

Some intermediate compositions (i.e. mixed cation species) between the individual minerals also occur.

Additionally, a further carbonate structure type, principally Vaterite (metastable CaCO₃) is also claimed as being relevant to the present invention. Representative values for the solubilities of divalent cationic carbonates and related substances relevant to the present invention are listed in the table below:

TABLE 4
Solubility Product Values of divalent carbonates

| Composition and | | |
|---|---|---|
| Compound | Solubility Product (Ksp) | Log Ksp |
| CaCO₃ | 4.8 × 10⁻⁹ | −8.319 |
| (Calcite) | 3.31 × 10⁻⁹ | −8.480 |
| CaCO₃ | 6.0 × 10⁻⁹ | −8.222 |
| (Aragonite only) | 4.61 × 10⁻⁹ | −8.33 |
| CdCO₃ | 2.5 × 10⁻¹⁴ | −13.602 |
| (Otavite) | 7.94 × 10⁻¹³ | −12.100 |
| CoCO₃ | 8.0 × 10⁻¹³ | −12.097 |
| (Sphaerocobaltite) | | |
| SrCO₃ | 9.4 × 10⁻¹⁰ | −9.027 |
| (Strontianite) | 5.358 × 10⁻¹⁰ | −9.271 |
| PbCO₃ | 1.5 × 10⁻¹³ | −12.824 |
| (Cerrusite) | 7.413 × 10⁻¹⁴ | −13.129 |
| BaCO₃ | 8.1 × 10⁻⁹ | −8.092 |
| (Witherite) | 2.74 × 10⁻⁹ | −8.562 |
| FeCO₃ | 3.5 × 10⁻¹¹ | −10.456 |
| (Siderite) | 3.55 × 10⁻¹¹ | −10.450 |
| | 1.288 × 10⁻¹¹ | −10.890 |
| MnCO₃ | 1.8 × 10⁻¹¹ | −10.745 |
| (Rhodochrosite) | 4.074 × 10⁻¹¹ | −10.390 |
| ZnCO₃ | 1.5 × 10⁻¹¹ | −10.824 |
| (Smithsonite) | 1 × 10⁻¹⁰ | −10.000 |
| MgCO₃ | 6.8 × 10⁻⁶ | −5.167 |
| (Magnesite) | 9.35 × 10⁻⁹ | −8.029 |
| NiCO₃ | 6.6 × 10⁻⁹ | −8.180 |
| (Gaspeite) | 1.445 × 10⁻⁷ | −6.842 |
| CuCO₃ | 2.344 × 10⁻¹⁰ | −9.630 |
| CaMg(CO₃)₂ | 3.98 × 10⁻¹⁸ | −17.4 |
| (Dolomite) | 2.88 × 10⁻¹⁷ | −16.54 |
| CaMg₃(CO₃)₄ | 1.08 × 10⁻³⁰ | −29.967 |
| (Huntite) | | |
| CaMn(CO₃)₂ | 1.7 × 10⁻²¹ | −20.770 |
| (Kutnahoride) | | |
| BaMg(CO₃)₂ | 1.91 × 10⁻¹⁷ | −16.719 |
| (Norsethite) | | |

TABLE 5
Solubility Product Values of other relevant substances

| Compound | Composition | Ksp | Log Ksp |
|---|---|---|---|
| Hydromagnesite | (Mg₅(CO₃)₄(OH)₂ | 1.730 × 10⁻⁹ | −8.762 |
| Anhydrite | CaSO₄ | 4.365 × 10⁻⁵ | −4.36 |
| Gypsum | CaSO₄•2H₂O | 2.63 × 10⁻⁵ | −4.58 |
| *Brucite | Mg(OH)₂ | 1.8 × 10⁻¹¹ | −10.745 |
| Nahcolite | NaHCO₃ | 2.831 × 10⁻¹ | −0.548 |
| Trona | NaHCO₃NaCO₃•2H₂0 | 1.603 × 10⁻¹ | −0.795 |
| Natron | Na₂CO₃•10H₂O | 4.887 × 10⁻² | −1.311 |
| Thermonatrite | Na₂CO₃•1H₂O | 1.333 × 10⁰ | +0.1249 |
| Celestite | SrSO₄ | 2.344 × 10⁻⁷ | −6.630 |
| Barite | BaSO₄ | 1.072 × 10⁻¹⁰ | −9.970 |
| Witherite | BaCO₃ | 2.74 × 10⁻⁹ | −8.562 |
| Nesquehonite | MgCO₃•3H₂O | 2.393 × 10⁻⁶ | −5.533 |
| Anglesite | PbSO₄ | 1.622 × 10⁻⁸ | −7.790 |
| Hydrocerrusite | 2PbCO₃Pb(OH)₂ | 3.467 × 10⁻¹⁸ | −17.460 |

### Step (a) of the Process for the Production of Divalent Cationic Halides

The CO₂ for step (a) of the process, the bicarbonation step, may be obtained from a carbon dioxide containing gas and/or from the atmosphere, or may be obtained from some other source. Examples of carbon dioxide containing gases include air, exhaust gas, flue gas, fermentation gas, cement and lime calciner off-gas, etc.

The process may include the preliminary step of generating at least part of the CO₂ for the bicarbonation reaction step. The CO₂ may be generated by reacting a cationic carbonate with an acid, preferably a strong acid such as H₂SO₄, HNO₃, H₃PO₄, CF₃CO₂H, HBr, Hl or HCl or any combination of such acids.

The process may further include the step of reacting the monovalent cationic hydrogen carbonate formed in the ion exchange step with a divalent cationic sulphate to produce the corresponding cationic carbonate and monovalent cationic sulphate. This step may comprise adjusting the pH, for example by adding a base (e.g. hydroxide).

The process may also include the step of recycling any CO₂ released from subsequent step(s) to the bicarbonation step.

Step (a) may be performed within an enclosed chamber. The enclosed chamber may contain a CO₂ containing atmosphere. at ambient temperature, or may be at some other temperature, e.g. between about 5 and 60° C., or between about 5 and 50, 5 and 30, 5 and 20, 5 and 10, 10 and 60, 20 and 60, 40 and 60, 10 and 50, 20 and 50, 10 and 40 or 20 and 30° C., e.g. about 5, 10, 15, 20, 25, 30, 35, 40, 45, 50, 55 or 60° C., or at some other suitable temperature. The CO₂ containing atmosphere may be at a total pressure of from about 0.0003 atmosphere to about 10 atmospheres, or about 0.001 to 10, 0.005 to 10, 0.01 to 10. 0.05 to 10, 0.1 to 10, 0.5 to 10, 1 to 10, 2 to 10, 5 to 10, 0.0003 to 1, 0.0003 to 0.1, 0.0003 to 0.01, 0.0003 to 0.0005, 0.001 to 1, 0.01 to 1, 0.1 to 1 or 0.001 to 0.1 atmospheres, for example about 0.0003, 0.0004, 0.0005, 0.0006, 0.0007, 0.0008, 0.0009, 0.001, 0.005, 0.01, 0.05, 0.1, 0.5, 1, 2, 3, 4, 5, 6, 7, 8, 9 or 10 atmospheres. It may have a CO₂ partial pressure ranging from about 0.0003 to about 0.5 atmospheres, or about 0.001 to 0.5, 0.005 to 0.5, 0.01 to 0.5. 0.05 to 0.5, 0.1 to 0.5, 0.2 to 0.5, 0.3 to 0.5, 0.0003 to 0.1, 0.0003 to 0.01, 0.0003 to 0.0005, 0.001 to 0.2, 0.01 to 0.3 or 0.001 to 0.1 atmospheres, for example about 0.0003, 0.0004, 0.0005, 0.0006, 0.0007, 0.0008, 0.0009, 0.001, 0.005, 0.01, 0.05, 0.1, 0.2, 0.3, 0.4 or 0.5 atmospheres.

The CO₂ containing atmosphere may be a gas obtained from or comprising a flue gas. It may alternatively be or it may comprise air. It may have a CO₂ content ranging from about 300 parts per million (i.e. about 0.03 vol %) to about 50 vol %, or about 0.05 to 50, 0.1 to 50, 0.5 to 50, 1 to 50, 5 to 50, 10 to 50, 20 to 50, 0.03 to 10, 0.03 to 1, 0.03 to 0.3, 0.03 to 0.1, 0.03 to 0.05, 0.05 to 10, 0.1 to 10, 1 to 10, or 1 to 20 vol %, e.g. about 0.003, 0.005, 0.01, 0.05, 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45 or 50 vol %.

The dissolution of carbon dioxide in step (a) may involve either the first or all three of the following reactions:

CO_{2(g)}+H₂O→H₂CO₃ (1)

H₂CO₃⁻→H⁺+HCO₃²⁻ (2)

HCO₃⁻→H⁺+CO₃²⁻ (3)

In dilute aqueous solutions ion dissociation is virtually complete. However, in contrast sea water is a complex, multi-component aqueous electrolyte of reasonably high ionic strength (| is commonly about 0.75). In such solutions, ion association is appreciable whereby every cationic species interacts to some extent with every anionic species in the solution to form associated ions in the solution. This interaction modifies the chemical activity of all ionic species in solution including the free ions.

The extent of this interaction is ionic strength (concentration) dependent. By modifying the activity of the free ions, ion association in solution may play a significant role in nucleation, growth and precipitation reactions. In sea water of approximately 35 ppt and pH 8.3 (See Table 6) the following association reactions may be simply represented qualitatively as:

(mNa) Total concentration=mNa⁺(free ion)+mNaOH⁰+mNaCl⁰+mNaSO₄₋+mNaHCO₃⁰+mNaCO₃⁻+mNaHSO₄⁰

(mK) Total=mK⁺(free)+mKOH⁰+mKCl⁰+mKSO₄⁻+mKHCO₃⁰+mKCO₃⁻+mKHSO₄⁰

(mCa) Total=mCa²⁺(free)+mCaOH⁺+mCaCl⁺+mCaSO₄⁰+mCaHCO₃⁺+mCaCO₃⁰+mCaHSO₄⁺

(mMg) Total=mMg²⁺(free)+mMgOH⁺+mMgCl⁺+mMgSO₄⁰+mMgHCO₃⁺+mMgCO₃⁰+mMgHSO₄⁺

(mH) Total=mH⁺(free)+mHOH⁰+mHCl⁰+mHSO₄⁻+m(H₀HCO₃)⁰+mHCO₃⁻+mH₂SO₄⁰

(mCl) Total=mCl⁻(free)+mNaCl⁰+mKCl⁰+mCaCl⁺+mMgCl⁺+mHCl⁰

(mHCO₃) Total=mHCO₃⁻(free)+mNaHCO₃⁰+mKHCO₃⁰+mCaHCO₃⁺+mMgHCO₃⁺+mHHCO₃⁰

(mCO₃) Total=mCO₃²⁻(free)+mNaCO₃⁻+mKCO₃⁻+mCaCO₃⁰+mMgCO₃+mHCO₃⁻

(mSO₄) Total=mSO₄²⁻(free)+mNaSO₄⁻+mKSO₄⁻+mCaSO₄⁰+mMgSO₄⁰+mHSO₄⁻

(mHSO₄) Total=mNaHSO₄⁰+mKHSO₄⁰+mCaHSO₄⁺mMgHSO₄⁺+mH₂SO₄⁰

TABLE 6
Simple major component composition of sea water of 35ppt salinity

| Ion | CaCO₃ ppm | Atomic Weight | Concentration |
|---|---|---|---|
| Cl⁻ | 19.010 | 35.49 | 0.536M |
| SO₄²⁻ | 2640 | 96.08 | 0.027M |
| HCO₃_{^{−}} | 120 | 61 | 0.0020M |
| Na⁺ | 10.800 | 22.98 | 0.470M |
| Mg²⁺ | 1300 | 24.32 | 0.053M |
| Ca²⁺ | 400 | 40.08 | 0.010M |
| K⁺ | 380 | 39.1 | 0.0097M |

The bicarbonation reaction in step (a) may involve any one or more of the following chemical reactions:

MgCO₃+H₂CO₃→Mg(HCO₃)₂ (4)

MgCO₃+H₂O+CO₂→Mg(HCO₃)₂ (5)

CaCO₃+H₂CO₃→Ca(HCO₃)₂ (6)

CaCO₃+H₂O+CO₂→Ca(HCO₃)₂ (7)

MgO+2H₂CO₃→Mg(HCO₃)₂→H₂O (8)

MgO+H₂O→2CO₂→Mg(HCO₃)₂ (9)

CaO+2H₂CO₃→Ca(HCO₃)₂+H₂O (10)

CaO+H₂O+2CO₂→Ca(HCO₃)₂ (11)

Mg(OH)₂+2H₂CO₃→Mg(HCO₃)₂+2H₂O (12)

Mg(OH)₂+2CO₂→Mg(HCO₃)₂ (13)

Ca(OH)₂+2H₂CO₃→Ca(HCO₃)₂+2H₂O (14)

Ca(OH)₂+2CO₂→Ca(HCO₃)₂ (15)

Similar equations may be written for other members of the group of cations including Sr, Ba, Pb, Co, Ni, Fe, Mn, Zn, Cd and Cu.

The divalent cation may be calcium or magnesium, or a combination thereof. Thus, in step (a) calcium carbonate or magnesium carbonate or a combination thereof may be reacted with carbon dioxide or a derivative thereof when it is dissolved in water.

Where calcium carbonate is used, it may be in the form of calcite or aragonite. When calcium carbonate is combined with magnesium carbonate, the divalent cationic carbonate may be in the form of dolomite or huntite. The calcium and/or magnesium carbonate may be in the form of a mineral comprising also one or more metal carbonates.

The calcium and/or magnesium carbonate may contain hydroxide and/or oxide and/or hydroxide groups, whether or not in combination with other elements or groups of elements.

Compounds of calcium that may be used in step (a) include oxides, hydroxides, limestone [CaCO₃], calcite [CaCO₃], vaterite [CaCO₃] and aragonite [CaCO₃]. The compound of calcium may be at least partially calcined.

Compounds of magnesium that may be used in step (a) include the normal carbonates of magnesium, including magnesite [MgCO₃], magnesium oxide [MgO], barringtonite [MgCO₃.2H₂O], nesquehonite [MgCO₃.3H₂O] and lansfordite [MgCO₃.5H₂O], as well as the basic (or hydroxyl-containing) carbonates of magnesium having the general formula XMgCO₃.yMg(OH)₂.zH₂O, including artinite [MgCO₃.Mg(OH)₂.3H₂O], hydromagnesite [4MgCO₃.Mg(OH)₂.4H₂O], dypingite [4MgCO₃.Mg(OH)₂.5H₂O], and an as yet unnamed octahydrate [4MgCO₃.Mg(OH)₂.8H₂O]. The compound of magnesium may be at least partially calcined.

It has been found that the pentahydrate or dypingite form of magnesium carbonate hydroxide works particularly well.

Double salt (i.e. mixed cation) carbonates that may used include huntite [CaMg₃(CO₃)₄], dolomite [CaMg(CO₃)₂] and other double salt carbonates involving Ca, Mn, Ba and/or Sr. The double salt carbonate may contain hydroxide and/or oxide and/or hydroxide groups, whether or not in combination with other elements or groups of elements and may be at least partially calcined.

The calcium and/or magnesium carbonate or oxide may conveniently be in the form of an anhydrous powder. However, where calcium and/or magnesium carbonate is available as an aqueous slurry or paste, it will have the advantage that it could be mixed with the carbonated water more easily. Typical particle sizes (i.e. mean particle diameters) are about 0.05 μm to about 0.20 μm, or about 0.05 to 0.1, 0.1 to 0.2 or 0.1 to 0.15 μm, e.g. about 0.05, 0.06, 0.07, 0.08, 0.09, 0.1, 0.11, 0.12, 0.13, 0.14, 0.15, 0.16, 0.17, 0.18, 0.19 or 0.2 μm, or may be greater than about 0.2 μm, e.g. 0.3, 0.4 or 0.5 μm.

In step (a), the mass of the carbon dioxide used, the mass of the calcium or magnesium carbonate used and the mass of the water present may be such as to yield a desired concentration of calcium or magnesium bicarbonate in the solution formed after reaction of the said substances in the reaction mixture.

The mass of the carbon dioxide used to prepare the solution of step (a), the mass of the calcium magnesium carbonate mixed into the reaction mixture of step (a) and the mass of the water present may be such as to yield a desired pH in the solution formed in step (a), after reaction of the said substances in the reaction mixture.

The calcium and/or magnesium carbonate is preferably in a particulate form. The calcium and/or magnesium carbonate may be in the form of a powder. Alternatively, it may be in the form of granules. To facilitate dispersion of the calcium and/or magnesium carbonate in the water, a paste of the calcium and/or magnesium carbonate may first be prepared by wetting the particulate calcium and/or magnesium carbonate, which may be in the form of a powder or granules, with a small amount of water or other suitable liquid.

In order to impede the carbon dioxide from escaping from the water, it may be kept under a blanket of carbon dioxide whilst the reaction between the substances of the reaction mixture is in progress. The blanket of carbon dioxide may by under a pressure which may be higher than atmospheric pressure. The pressure of the carbon dioxide, and accordingly on the body of water, may be from a few kPa to several hundreds or several thousands of kPa. The pressure or partial pressure of the carbon dioxide over the water may be from about 0.0003 atmospheres to about 10 atmospheres, or about 0.001 to 10, 0.005 to 10, 0.01 to 10. 0.05 to 10, 0.1 to 10, 0.5 to 10, 1 to 10, 2 to 10, 5 to 10, 0.0003 to 1, 0.0003 to 0.1, 0.0003 to 0.01, 0.0003 to 0.0005, 0.001 to 1, 0.01 to 1, 0.1 to 1 or 0.001 to 0.1 atmospheres, for example about 0.0003, 0.0004, 0.0005, 0.0006, 0.0007, 0.0008, 0.0009, 0.001, 0.005, 0.01, 0.05, 0.1, 0.5, 1, 2, 3, 4, 5, 6, 7, 8, 9 or 10 atmospheres. It has been found that the higher the partial pressure of the carbon dioxide within the aforementioned ranges of pressure, the less carbon dioxide escapes from the solution before the reaction is complete. The process according the invention may include the step of controlling the pressure, during step (a), at an absolute pressure of from about 0.0003 atmospheres to about 10 atmospheres, or about 0.001 to 10, 0.005 to 10, 0.01 to 10. 0.05 to 10, 0.1 to 10, 0.5 to 10, 1 to 10, 2 to 10, 5 to 10, 0.0003 to 1, 0.0003 to 0.1, 0.0003 to 0.01, 0.0003 to 0.0005, 0.001 to 1, 0.01 to 1, 0.1 to 1 or 0.001 to 0.1 atmospheres, for example about 0.0003, 0.0004, 0.0005, 0.0006, 0.0007, 0.0008, 0.0009, 0.001, 0.005, 0.01, 0.05, 0.1, 0.5, 1, 2, 3, 4, 5, 6, 7, 8, 9 or 10 atmospheres.

The process according to invention may comprise a step wherein an aqueous slurry is prepared from a particulate calcium and/or magnesium carbonate and water, before the slurry is mixed with an aqueous solution of carbon dioxide or a derivative thereof. The derivative may be carbonic acid and the carbonic acid may be dissociated or partially dissociated.

In step (a), the temperature of the water may be from about 0° C. to about 50° C., alternatively from about 0° C. to about 40° C., preferably from about 0° C. to about 30° C., more preferably from about 5° C. to about 30° C., still more preferably from about 10° C. to about 30° C., and may be about 0, 5, 10, 15, 20, 25, 30, 35, 40, 45 or 50° C.

It has been found that the higher the partial pressure of the carbon dioxide and the lower the temperature of the water within the aforementioned ranges of temperature and pressure, the easier it is to cause the carbon dioxide to react with the carbonate.

The process may include the step of controlling the pH of the aqueous solution containing calcium or magnesium bicarbonate so that the final pH thereof falls within a range of from about 7.5 to about 9.0 or within a range of from about 7.5 to about 8.5, 7.5 to 8.0, 8.0 to 9.0, 8.5 to 9.0 or 8.0 to 8.5, preferably between about 7.8 and about 8.4, for example about 7.5, 7.6, 7.7, 7.8, 7.9, 8.0, 8.1, 8.2, 8.3, 8.4, 8.5, 8.6, 8.7, 8.8, 8.9 or 9.0.

The pH may be controlled by decreasing or increasing the pH of the reaction mixture and of the resulting aqueous solution containing calcium and/or magnesium bicarbonate, by dissolving in the reaction mixture more or less additional carbon dioxide. Alternatively, the pH of the reaction mixture may be controlled by increasing or decreasing the amount of calcium and/or magnesium carbonate introduced into the suspension. As another alternative, the pH may be controlled by introducing into the solution protons or a substance which has an effect on the pH, e.g. an acid or a buffer.

The aqueous solution of calcium and/or magnesium bicarbonate obtained may have a concentration of bicarbonate anions from about 120 mg per litre to about 650 mg per litre, more particularly from about 180 mg per litre to 400 mg per litre, even more particularly from about 180 mg per litre to 250 mg per litre, for example between about 120 and 600, 120 and 500, 120 and 400, 120 and 300, 120 and 200, 200 and 650, 300 and 650, 400 and 650, 150 and 500, 150 and 300 or 150 and 200 mg per litre, e.g. about 120, 130, 140, 150, 160, 170, 180, 190, 200, 250, 300, 350, 400, 450, 500, 550, 600 or 650 mg per litre.

The calcium and/or magnesium carbonate is preferably contacted with a stoichiometric quantity of carbon dioxide and/or species resulting from the dissolution of carbon dioxide in water, or with a quantity of such carbon dioxide or such species which exceeds a stoichiometric quantity by from about 0% to about 20%, preferably by no more than about 10%, more preferably, by no more than about 1% to about 5%, e.g. by no more than about 0.5, 1, 2, 3, 4, 5, 6, 7, 8, 9, 10, 11, 12, 13, 14, 15, 16, 17, 18, 19 or 20%.

It is to be understood that, at lower temperatures, the extent of dissolution of carbon dioxide in water is greater than at higher temperatures.

Step (a) may be conducted either continuously or batchwise. The reaction rate may be increased by increasing the temperature or by increasing the intimacy of contact between the carbon dioxide and the carbonate, oxide and/or hydroxide.

### Step (b) of the Process for the Production of Divalent Cationic Halides

In step (b) of the process according to the invention, the calcium and/or magnesium (or cationic) hydrogen carbonate (or bicarbonate) solution produced in step (a) is fed to an ion exchange reactor where it is contacted with the ion exchange medium to cause the divalent cation to be exchanged for a monovalent cation.

The monovalent cation may be sodium or potassium.

The halide may be fluoride, chloride, bromide or iodide, or a mixture of any two or more thereof. It is preferably chloride.

The cation exchange may be described by one or more of the following equations:

Generically:

X(HCO₃)₂+2Na⁺2NaHCO₃+X²⁺ (16)

Mg(HCO₃)₂+2Na⁺→2NaHCO₃+Mg²⁺ (17)

Ca(HCO₃)₂+2Na⁺2NaHCO₃+Ca²⁺ (18)

Mg(HCO₃)₂+2K⁺→2KHCO₃+Mg²⁺ (19)

Ca(HCO₃)₂+2K⁺→2KHCO₃+Ca²⁺ (20)

where X is a member of the divalent cation group. Similar equations may be written for other members of the group of divalent cations.

The ion exchange reactor may comprise a horizontal bed of an ion exchange medium, through which the cationic hydrogen carbonate solution may be passed. Alternatively, the ion exchange reactor may comprise a column, a tube reactor or any other known reactor type. There may be more than one ion exchange medium. If so, they may be connected in parallel or in series, or some may be parallel and some in series. The ion exchange reactor may be sealed to prevent or hinder escape of CO₂ to the atmosphere.

The ion exchange step (b) may be conducted at ambient temperature, or at some other temperature, e.g. between about 5 and 60° C., or between about 5 and 30, 5 and 20, 5 and 10, 10 and 60, 20 and 60, 10 and 50, 20 and 50, 10 and 40 or 20 and 30° C., e.g. about 5, 10, 15, 20, 25, 30, 35, 40, 45, 50, 55 or 60° C., or at some other suitable temperature.

During ion exchange, the divalent cations, e.g. calcium or magnesium ions, may be taken up by the ion exchange medium in exchange for the release of monovalent cations e.g. sodium or potassium ions, so that a monovalent cation (e.g. sodium or potassium) hydrogen carbonate (or bicarbonate) solution may be produced.

Regeneration of the ion exchange medium may be performed by passing a concentrated sodium or potassium halide solution through the bed, causing the medium to take up sodium or potassium ions and to release the divalent cations, such as calcium or magnesium ions, in the form of a divalent cation, e.g. calcium or magnesium, halide solution.

Preferred ion exchange media are those which can be regenerated directly with a sodium or potassium halide solution, preferably NaCl, without requiring an intermediate acid regeneration step. Suitable ion exchange media include natural aluminosilicates such as zeolites (natural and synthetic) and clays. Smectites (montmorillonites) and kandites (kaolin group) are examples of suitable materials. It will be understood that, although these ion exchange media may not require acid regeneration at each regeneration it may still be necessary occasionally to regenerate the medium with dilute HCl when the ion exchange capacity of the medium decreases.

### Step (c) of the Process for the Production of Divalent Cationic Halides

The monovalent cationic halide may be an aqueous solution of a chloride, a bromide or an iodide of lithium, sodium or potassium, or a combination of any two or more thereof.

The divalent cationic halide is preferably in solution, preferably an aqueous solution.

The solution of the monovalent cationic halide preferably has a concentration low enough to ensure that the divalent cationic halide remains in solution. On the other hand, the solution of monovalent cationic halide preferably has a concentration high enough to ensure that the volume of the solution of monovalent cationic halide fed to the ion exchange medium and the volume of the solution of divalent cationic halide recovered from the ion exchange medium are kept small so that handling costs can be minimized.

### Method of Sequestering Carbon Dioxide

In accordance with a second aspect of the invention, there is provided a method of sequestering carbon dioxide comprising:

(a) reacting the carbon dioxide with a carbonate of a divalent cation (i.e. a divalent cationic carbonate), such as calcium carbonate and/or magnesium carbonate, and water, and/or with a species resulting from the dissolution of the carbon dioxide in water, to form an aqueous solution of a bicarbonate of the divalent cation, such as calcium bicarbonate and/or magnesium bicarbonate;

(b) exchanging the divalent cation(s), e.g. calcium and/or magnesium ions, present in said aqueous solution for one or more monovalent cations including sodium and/or potassium ions in an ion exchange medium, thereby forming an aqueous solution of a bicarbonate of a monovalent cation, e.g. sodium bicarbonate and/or potassium bicarbonate; and

(c) recovering said bicarbonate of the monovalent cation (e.g. sodium bicarbonate and/or potassium bicarbonate) from the aqueous solution by evaporating water from the aqueous solution.

The ion exchange medium may be regenerated when required, by contacting it with a hydrohalic acid such as hydrochloric acid to form an aqueous solution of the corresponding calcium halide, e.g. calcium chloride.

### Apparatus for Production of Divalent Cationic Halides

According to a third aspect of the invention, there is provided an apparatus for the production of divalent cationic halides, comprising:

(a) a bicarbonator reactor for reacting a divalent cationic carbonate with CO₂ and water and/or a derivative thereof, to form a divalent cationic hydrogen carbonate or bicarbonate wherein said divalent cation is capable of forming a carbonate that has a low solubility in water;

(b) an ion exchange medium for exchanging the cation of the divalent cationic hydrogen carbonate or bicarbonate formed in the bicarbonator reactor for a monovalent cation to produce a monovalent cationic hydrogen carbonate; and

(c) means for regenerating the ion exchange medium with a monovalent cationic halide to produce said divalent cationic halide. The means may be an ion exchange medium regenerator.

The ion exchange medium may be located within a housing, e.g. a bed, a column or some other suitable housing, as is well known in the art.

The bicarbonate reactor may be adapted to be operated at a pressure of from about 0.0003 atmospheres to about 10 atmospheres, or about 0.001 to 10, 0.005 to 10, 0.01 to 10. 0.05 to 10, 0.1 to 10, 0.5 to 10, 1 to 10, 2 to 10, 5 to 10, 0.0003 to 1, 0.0003 to 0.1, 0.0003 to 0.01, 0.0003 to 0.0005, 0.001 to 1, 0.01 to 1, 0.1 to 1 or 0.001 to 0.1 atmospheres, for example about 0.0003, 0.0004, 0.0005, 0.0006, 0.0007, 0.0008, 0.0009, 0.001, 0.005, 0.01, 0.05, 0.1, 0.5, 1, 2, 3, 4, 5, 6, 7, 8, 9 or 10 atmospheres. It may be operated at atmospheric pressure when used for large scale, one-way uptake of carbon dioxide from the atmosphere.

Apparatus for Sequestration of Carbon Dioxide from Flue Gases, Air, Exhaust Gas, Flue Gas, Fermentation Gas, Cement and Lime Calciner Off-Gas

According to a fourth aspect of the invention, there is provided an apparatus for the sequestration of carbon dioxide from flue gases, air, exhaust gas, flue gas, fermentation gas, cement and lime calciner off-gas, comprising:

(a) a bicarbonator reactor for reacting a divalent cationic carbonate with the said flue gases, air, exhaust gas, flue gas, fermentation gas, cement and lime calciner off-gas, in the presence of water, to form a divalent cationic hydrogen carbonate or bicarbonate wherein said divalent cation is capable of forming a carbonate that has a low solubility in water;

(b) an ion exchange medium for exchanging the cation of the divalent cationic hydrogen carbonate or bicarbonate formed in the bicarbonator reactor for a monovalent cation to produce a monovalent cationic hydrogen carbonate; and

(c) means for regenerating the ion exchange medium with a monovalent cationic halide to produce said divalent cationic halide.

The apparatus may comprise means, e.g. a contactor, for contacting the ion exchange medium with hydrochloric acid to form an aqueous solution of calcium chloride.

The bicarbonate reactor may comprise means for controlling the pressure of the bicarbonator reactor between about 0.0003 atm and about 10 atm. It may be operated at atmospheric pressure.

### Processes for Sequestration of Atmospheric CO₂

According to a fifth aspect of the invention, there is provided an apparatus for the production of divalent cationic halides, comprising:

(a) a bicarbonator reactor for reacting a divalent cationic carbonate with the atmosphere in the presence of water, to form a divalent cationic hydrogen carbonate or bicarbonate wherein said divalent cation is capable of forming a carbonate that has a low solubility in water;

(b) an ion exchange medium for exchanging the cation of the divalent cationic hydrogen carbonate or bicarbonate formed in the bicarbonator reactor for a monovalent cation to produce a monovalent cationic hydrogen carbonate; and

(c) means for regenerating the ion exchange medium with a monovalent cationic halide to produce said divalent cationic halide.

The apparatus may comprise means for contacting the ion exchange medium with hydrochloric acid to form an aqueous solution of calcium chloride.

The bicarbonate reactor may comprise means for controlling the pressure of the bicarbonator reactor between about 0.0003 atmospheres and about 10 atmospheres, or about 0.001 to 10, 0.005 to 10, 0.01 to 10. 0.05 to 10, 0.1 to 10, 0.5 to 10, 1 to 10, 2 to 10, 5 to 10, 0.0003 to 1, 0.0003 to 0.1, 0.0003 to 0.01, 0.0003 to 0.0005, 0.001 to 1, 0.01 to 1, 0.1 to 1 or 0.001 to 0.1 atmospheres, for example to about 0.0003, 0.0004, 0.0005, 0.0006, 0.0007, 0.0008, 0.0009, 0.001, 0.005, 0.01, 0.05, 0.1, 0.5, 1, 2, 3, 4, 5, 6, 7, 8, 9 or 10 atmospheres.

### Process for Sequestration of CO₂ Using a Body of Supersaturated Carbonate Containing Brine

In accordance with a sixth aspect, the present invention provides a process for sequestration of CO₂, including the steps of:
adding a divalent cationic halide to a body of supersaturated carbonate-containing brine which is in contact with a CO₂-containing atmosphere so as to cause the divalent cationic halide to form a divalent cationic carbonate having low solubility; and
causing the divalent cationic carbonate to precipitate from the body of carbonate containing brine.

The step of adding the divalent cationic halide to the body of brine may itself cause the divalent cationic carbonate to precipitate. Optionally, the process according to the sixth aspect of the invention comprises the step of dissolving CO₂ in the brine. The brine may be buffered, thereby reducing formation of bicarbonate species from the carbonate. The step of causing the divalent cationic carbonate to precipitate may comprise adding a nucleating agent to the body of carbonate containing brine.

The process may further include the steps of collecting and disposing of the cationic carbonate precipitated. The collecting may comprise filtering, settling, centrifuging or some other suitable process or a combination of such processes. The disposing may comprise dumping, is burying, encapsulating or some other suitable process or a combination of such processes, or may comprise optionally purifying and selling the cationic carbonate, or may comprise some other form of reuse or recycling.

In this aspect, the divalent cation of the divalent cationic halide is the same as the divalent cation of the divalent cationic carbonate. The brine is supersaturated with respect to the carbonate of the divalent cation of the divalent cationic halide. The brine may be supersaturated with respect to carbonates of divalent cations including calcium and/or magnesium carbonate. The brine may be sea water.

The CO₂-containing atmosphere may be air or a flue gas.

According to a seventh aspect of the present invention, there is provided a process for enhancing precipitation of calcium carbonate from supersaturated seawater, comprising adding a nucleating agent to the sea water, wherein the nucleating agent is capable of facilitating the formation of calcite and/or dolomite; and causing calcite and/or dolomite to precipitate from the seawater.

According to an eighth aspect of the present invention, there is provided a process for enhancing precipitation of magnesium carbonate from supersaturated seawater, comprising adding a nucleating agent to the sea water, wherein the nucleating agent is adapted to facilitate the formation of magnesite; and causing magnesite to precipitate from the sea water.

It is recognised that precipitation is a complex phenomenon involving some or all of the following processes:
Nucleation
Crystal growth
Ostwald ripening
Recrystallisation
Coagulation
Agglomeration

It is also recognised that each of these steps must be controlled to create a well defined morphology.

In solution, nucleation can be achieved, in the context of this patent, by:
Increasing the concentration of the precipitating solute species by direct reactions of ions including Ca²⁺, Mg²⁺, Na⁺, CO₃²⁻ and HCO₃—.

Promoting the homogeneous or heterogeneous nucleation step by adding a compound or compounds in fine particulate or slurry form that provide pre-existing orientated surfaces for protocrystals to form and grow so that they achieve stability.

A wide range of materials may be used to assist nucleation including limestone, calcite, dolomite, vaterite, clay minerals, purified bovine carbonic anhydrase, purified human carbonic anhydrase, calcium oxalate, sodium carbonate, porphyrin amphiphiles, magnetic fields, proteins, sodium oleate and a range of natural poorly defined soap compounds including sapo animals (curd soap), sap durus (hard shap) and sap mollis (soft soap).

It is recognised that during crystal growth particles are formed over a wide range of particle sizes and that secondary nucleation may occur during the growth period. Rates of growth may be controlled by either diffusion of dissolved species to the particle or by the rate of condensation, from dissolved species to the particle.

Furthermore, during Ostwald ripening small particles tend to dissolve and large particles are recrystallised. The smaller particles are more soluble than larger ones due to the excess of energy at the surface and thus, larger particles grow at the expense of smaller ones. During aggregation particle growth is achieved by the adhesion of smaller primary particles to give larger secondary particles. This aggregation may be achieved by processes including controlled double jet precipitation.

In accordance with a ninth aspect, the present invention provides a process for sequestration of CO₂, including the steps of:

(a) reacting a divalent cationic carbonate, oxide or hydroxide with CO₂ and water and/or a species resulting from the dissolution of CO₂ in water, to form a divalent cationic hydrogen carbonate or bicarbonate;

(b) exchanging a divalent cation of the divalent cationic hydrogen carbonate or bicarbonate thus formed for a monovalent cation to produce a monovalent cationic hydrogen carbonate using an ion exchange medium;

(c) regenerating the ion exchange medium with a monovalent cationic halide to produce said divalent cationic halide,

(d) adding the divalent cationic halide to a body of supersaturated carbonate-containing brine which is in contact with a CO₂-containing atmosphere so as to cause the divalent cationic halide to form a divalent cationic carbonate having low solubility; and

(e) causing the divalent cationic carbonate to precipitate from the body of carbonate-containing brine.

The divalent cation of the divalent cationic halide is the same as the divalent cation of the divalent cationic carbonate. The brine is supersaturated with respect to the carbonate of the divalent cation of the divalent cationic halide.

The process of the ninth aspect may be operated as a flow through, or continuous, process. In this manner, water is being added to the system, either in a batchwise or a continuous manner, so that ongoing dissolution of carbon dioxide does not reduce the pH of the solution to the point where bicarbonates are formed. The step of causing the divalent cationic carbonate to precipitate may comprise adding a nucleating agent to the body of carbonate containing brine.

By precipitating calcium carbonate and/or magnesium carbonate, seawater absorbs more carbon dioxide from the atmosphere, and in this way, carbon dioxide is sequestered by the process in accordance with the invention.

In an embodiment, there is provided a process for sequestration of CO₂, including the steps of:

(a) reacting a divalent cationic carbonate, oxide or hydroxide with CO₂ and water and/or a species resulting from the dissolution of CO₂ in water, to form a divalent cationic hydrogen carbonate or bicarbonate;

(b) exchanging a divalent cation of the divalent cationic hydrogen carbonate or bicarbonate thus formed for a monovalent cation to produce a monovalent cationic hydrogen carbonate using an ion exchange medium;

(c) regenerating the ion exchange medium with a monovalent cationic halide to produce said divalent cationic halide,

(d) adding the divalent cationic halide to a body of supersaturated carbonate-containing brine which is in contact with a CO₂-containing atmosphere so as to cause the divalent cationic halide to form a divalent cationic carbonate having low solubility; and

(e) adding a nucleating agent to the body of carbonate-containing brine, thereby causing the divalent cationic carbonate to precipitate from the body of carbonate-containing brine.

The concentration of carbon dioxide in the atmosphere is commonly approximately 350 parts per million.

The inventors have observed that carbon dioxide is still absorbed by seawater even if the concentration in the atmosphere has been lowered to a concentration of approximately 150 parts per million in a closed loop system. In the natural system, the atmospheric concentration will be locally lowered by approximately 50 ppm.

It is also to be understood that the dissolution of carbon dioxide in seawater decreases with increasing temperature. As a consequence, an area having a low rainfall which is in close proximity to an ocean, and having a low sea water temperature is desirable for maximization of carbon dioxide super saturation.

### Apparatus for Sequestration of Atmospheric CO₂

In accordance with a tenth aspect of the invention, there is provided an apparatus for the sequestration of CO₂, comprising:
means (e.g. a contactor) for contacting a cationic halide to a body of carbonate-containing brine which is in contact with a CO₂-containing atmosphere so as to cause the cationic halide to form a cationic carbonate having low solubility which precipitates from the body of carbonate-containing brine; and
means (e.g. a separator) for separating the cationic carbonate from the body of carbonate containing brine.

In accordance with an eleventh aspect of the invention, there is provided an apparatus for the sequestration of CO₂, comprising means (e.g. a nucleator) for adding a nucleating agent to sea water containing carbonate ions in solution, so as to cause calcite and/or dolomite and/or magnesite and/or sodium carbonate phases to precipitate from the seawater.

### Supersaturation

Supersaturation is required for any crystallisation to occur. The larger the degree of supersaturation, the greater the driving force for the formation of crystals. Seawater is supersaturated with regard to calcium carbonate (CaCO₃) calcium magnesium carbonate phases and magnesium carbonate (MgCO₃). However, for various reasons, this state of supersaturation is maintained.

Normal open seawater contains from about 35 parts per thousand (or 35000 ppm) of total dissolved solids of which approximately 410 parts per million is in the form of Ca²⁺. The concentration of total dissolved solids is usually higher in areas where solar evaporation of water in a restricted area is high and dilution of the water back to average concentration is prevented or inhibited. In some isolated spots, the total dissolved solids may increase to about 42 parts per thousand (or 42000 ppm) as a result of evaporation of the sea water.

The Ca²⁺ present in supersaturated seawater is prevented from precipitating by the formation of ion pairs in solution, by complexes formed with organic substances, by the high ionic strength of seawater of about 0.7 and by other phenomena. Thus, the solubility of calcium carbonate in seawater may be up to about 10 times the solubility of calcium carbonate in fresh water at a given temperature.

Standard seawater is about 8 times supersaturated with regard to calcium carbonate about 5 times supersaturated with regard to magnesium carbonate.

It has been estimated that, of the approximately 410 parts per million calcium present in seawater, only approximately 155 parts per million is present as free calcium ions. The rest is present as ion pairs with sulphate, carbonate, phosphate, fluoride and other anions or are complexed by organic compounds.

Calcium carbonate, dolomite magnesium carbonate and/or sodium carbonate phases may be caused to precipitate from sea water by one of the following steps:

(i) providing a suitable nucleating agent or a template for crystallisation; and/or

(ii) by increasing the degree of supersaturation through evaporation of water from the seawater; and/or
(iii) by increasing the degree of supersaturation through increasing the temperature of the seawater.

### Nucleating Agent

As stated above, a cationic halide such as calcium chloride or magnesium chloride may be added to sea water as a nucleating agent to facilitate precipitation of calcium carbonate.

The cationic halide may be obtained from a process in accordance with the first aspect of the invention. Typically, concentrations of calcium chloride will be up to 0.1 molar or equivalent material added in solid form. Other means of achieving excess calcium concentration may be used, including calcium hydroxide and others as previously stated.

### Evaporation

In solar evaporation ponds, a clay may be deposited on the bottom of an evaporation pond to inhibit sea water from draining away. In order to enhance crystallization, clays may be added to the evaporating sea water to serve as a nucleating agent for calcium carbonate precipitation.

The depth of an evaporation point should be of the order of about 1 to about 1.5 metres with a maximum of about three metres in summer. The depth may be between about 1 and 3 metres, or between about 1 and 2, 2 and 3 or 1.5 and 2, and may be about 1, 1.5, 2, 2.5 or 3 metres.

A static pond should have a depth of about 1 to about 1.5 metres, or about 1 to 1.3, 1.2 to 1.5 or 1.1 to 1.4 metres, e.g. about 1.0, 1.1, 1.2, 1.3, 1.4 or 15 metres.

The pond should have a relative evenness of temperature, carbon dioxide concentration, etc. Alternatively, a canal flow through system may be used to achieve evaporation. Flow from this canal may be combined with static ponds to achieve further evaporation and/or precipitation.

The canal may be constructed so as to have a flow width of up to 20 m wide (e.g. about 5, 10, 15 or 20 m wide) and up to 2 m deep (e.g. about 0.5, 1, 1.5 or 2 m deep). The ratio of depth to width may be between about 1 to 50 and 1 to 5, or between about 1 to 50 and 1:10, 1:50 and 1:20, 1:20 and 1:5, 1:10 and 1:5 or 1:10 and 1:20, e.g. about 1:5, 1:6, 1:7, 1:8, 1:9, 1:10, 1:11, :12, 1:13, 1:14, 1:15, 1:20, 1:30, 1:40 or 1:50. The canal may shall be constructed so as to achieve a flow length by a sinuous path of up to 80 km (e.g. about 10, 20, 30, 40, 50, 60, 70 or 80 km). Flow rates shall be up to 5 km/hour although more typically shall be in the range of 0.1 to 2 km/hour. The flow rate may be between about 0.1 and 5, 1 and 5, 0.1 and 3, 0.1 and 1 or 0.5 and 1 km/hour, e.g. about 0.1, 0.2, 0.3, 0.4, 0.5, 0.6, 0.7, 0.8, 0.9, 1, 1.5, 2, 2.5, 3, 3.5, 4, 4.5 or 5 km/hour.

### Increasing or Decreasing the Temperature of the Sea Water

It is to be understood that the solubility of calcium carbonate is inversely proportional to temperature. Thus, the hotter the seawater, the lower the solubility of calcium carbonate. It may therefore be advantageous to heat the seawater, or brine, in order to encourage precipitation. The heating may be to a temperature of up to about 60° C., or up to about 50, 40 or 30° C., e.g. about 30, 35, 40, 45, 50, 55 or 60° C. The heating may be achieved by any known heater, e.g. an electric heater, a solar heater, a gas or fuel powered heater or some other heater.

### Crystallization Enhancement

Calcium carbonate may precipitate in various forms, including in the calcite, aragonite, vaterite dolomite and other forms.

Calcite is a stable phase. Its solubility is lower than the solubility of aragonite or vaterite.

The calcite and/or aragonite and/or vaterite and/or dolomite may be anhydrous or may contain crystal water. One hydrated form is monohydrocalcite (CaCO₃.H₂O). Other hydrates include crystalline magnesium carbonate hydrates.

When calcium carbonate and magnesium carbonate precipitate, calcium ions can be built into the magnesium carbonate structure and vice versa. In this way, dolomite can be formed as a layered deposit comprising alternating layers of calcium carbonate and magnesium carbonate.

With the intervention of enzymes or other biomaterial, monohydrate calcite may be formed. Calcite aragonite and vaterite are not normally precipitated from sea water without a biological intervention.

In one embodiment of the invention, calcium carbonate, magnesium carbonate, gypsum, sodium bicarbonate, sodium carbonate, brucite and dolomite are recovered from seawater.

One of the problems with magnesium carbonate is that it normally has a silica impurity which increases maintenance costs of processing equipment. The magnesium carbonate produced by this process does not contain significant silica.

One of the critical controls in the process according to the invention, is the phosphate level.

The solubility of gypsum is about 105 parts per thousand, whilst the solubility of sodium carbonate is approximately 150 to 1710 parts per thousand with significant differences between fresh and saline water.

The apparatus according to the invention may comprise a canal system with flowing seawater, with various products precipitating at various points along the canal. Further, in accordance with the invention, a desired product may be precipitated by mixing seawater from two or more canals.

It is also foreseen that other materials such as iodine and bromine may be recovered using the process according to the invention.

In order to produce products from seawater, large areas of flat country are required, for the construction of solar evaporation ponds. In addition, a suitable area must have a low rainfall or precipitation of water from the atmosphere or the evaporation of seawater exceeding precipitation for most of the time or fall all but a few days per annum.

Dolomite will not normally precipitate out unless the molar ratio of calcium to magnesium is in the range of 7 to 10.

The supersaturation of calcium in seawater is in the range of approximately 2 to 10 times the solubility of calcium carbonate in fresh water. The level of supersaturation is believed to be part real and part due to the modelling assumptions used.

Great variations exist in the results obtained from various mathematical models that are available for the calculation of the concentrations of various constituents of sea water.

At a temperature of 42° C., gypsum reaches a maximum solubility and starts to precipitate in an ideal, open system.

In a further aspect of the invention there is provided a process for sequestering carbon dioxide, including the steps of:

(a) reacting a carbonate, oxide or hydroxide of a divalent cation with the carbon dioxide and water and/or with a species resulting from the dissolution of the carbon dioxide in water, to form a hydrogen carbonate of the divalent cation; and

(b) exchanging the divalent cation of the hydrogen carbonate of the divalent cation formed in (a), using an ion exchange medium, for a monovalent cation to produce a solution of a hydrogen carbonate of the monovalent cation;

wherein said carbonate, oxide or hydroxide of the divalent cation has a low solubility in water.

The process may additionally comprise:

(c) regenerating the ion exchange medium with a halide of the monovalent cation or with a hydrohalic acid to produce a halide of the divalent cation.

The carbonate, oxide or hydroxide of the divalent cation may have a solubility product (Ksp) value at ambient temperature and pressure, of less than about 1×10⁻⁶. The divalent cation may be selected from the group consisting of calcium, magnesium, strontium, barium, lead, cadmium, zinc, cobalt, nickel, manganese, iron, the transition metals, and any combination thereof. The carbon dioxide for step (a) may be obtained from a carbon dioxide containing gas and/or from the atmosphere. The carbon dioxide containing gas may be selected from the group consisting of exhaust gas, flue gas, fermentation gas, cement and lime calciner off-gas, or may be some other carbon dioxide containing gas. The process may additionally comprise removing particles from the carbon dioxide containing gas. This may employ an agglomerator, an electrostatic precipitator and/or wet tunnel technologies.

The process may additionally comprise the preliminary step of generating at least part of the carbon dioxide for step (a). The hydrogen carbonate of the monovalent cation formed in step (b) may be reacted with a sulphate of a divalent cation to produce a carbonate of the divalent cation and a sulphate of the monovalent cation. Carbon dioxide released from subsequent step(s) may be recycled to step (a).

The process may be performed within an enclosed chamber. The enclosed chamber may contain a carbon dioxide containing atmosphere. The carbon dioxide containing atmosphere may be at a temperature of between about 5 and about 60° C., and may be at a total pressure of from about 0.0003 atmosphere to about 10 atmospheres. The carbon dioxide partial pressure in the enclosed chamber may range from about 0.0003 to about 0.5 atmospheres. The carbon dioxide containing atmosphere may have a carbon dioxide content ranging from about 300 parts per million (i.e. about 0.03 vol %) to about 50 vol %.

The carbonate, oxide or hydroxide of the divalent cation may be calcite, aragonite, dolomite, huntite, limestone, vaterite, magnesite, magnesium oxide, barringtonite, nesquehonite, lansfordite artinite, hydromagnesite, dypingite, or 4MgCO₃.Mg(OH)₂.8H₂O, or some other suitable material. It may be at least partially calcined. It may be in the form of an anhydrous powder or an aqueous slurry or a paste. Step (a) may comprise preparing an aqueous slurry from the carbonate, oxide or hydroxide of the divalent cation and water, and mixing the slurry with an aqueous solution of carbon dioxide or a derivative thereof.

The hydrogen carbonate of the divalent cation may be in an aqueous solution and the pH of said aqueous solution may be controlled so that the final pH thereof falls within a range of from about 7.5 to about 9.0.

The carbonate, oxide or hydroxide of the divalent cation may be contacted with a quantity of the carbon dioxide and/or species resulting from the dissolution of the carbon dioxide in water, which exceeds a stoichiometric quantity by from about 0% to about 20%.

The monovalent cation may be sodium or potassium, or may be rubidium, caesium or a mixture of said cations. The halide may be a fluoride, chloride, bromide, iodide, or a mixture of any two or more thereof.

The process may also comprise recovering the hydrogen carbonate of the monovalent cation from the solution of said hydrogen carbonate of the monovalent cation by evaporating water from said solution.

In another aspect of the invention there is provided an apparatus for sequestering carbon dioxide, comprising:

(a) a bicarbonator reactor for reacting a carbonate of a divalent cation with the carbon dioxide and water and/or with a species resulting from the dissolution of the carbon dioxide in water, to form a hydrogen carbonate of the divalent cation wherein said divalent cation is capable of forming a carbonate that has a low solubility in water; and

(b) an ion exchange medium for exchanging the divalent cation of the hydrogen carbonate formed in the bicarbonator reactor for a monovalent cation to produce a hydrogen carbonate of the monovalent cation.

The apparatus may also comprise an ion exchange medium regenerator for regenerating the ion exchange medium with a halide of the monovalent cation or with a hydrohalic acid to produce a halide of the divalent cation. The bicarbonate reactor may be adapted to be operated at a pressure of from about 0.0003 atm to about 10 atm. The apparatus may comprise an entrance port for admitting a carbon dioxide containing gas, for example for admitting exhaust gas, flue gas, fermentation gas, cement and lime calciner off-gas, or some other carbon dioxide containing gas. The apparatus may also comprise a particle remover for removing particles from the carbon dioxide containing gas. The particle remover may comprise one or more of an agglomerator, an electrostatic precipitator and wet tunnel technologies.

The apparatus may comprise means (e.g. a pressure controller) for controlling the pressure of the bicarbonator reactor between about 0.0003 atm and about 10 atm.

In another aspect of the invention there is provided a process for sequestration of carbon dioxide, including the steps of:
adding a halide of a divalent cation to a body of supersaturated carbonate-containing brine which is in contact with a CO₂-containing atmosphere so as to cause the halide of the divalent cation to form a carbonate of the divalent cation, said carbonate having low solubility; and
causing the carbonate of the divalent cation to precipitate from the body of carbonate containing brine.

The brine may be supersaturated with respect to carbonates of divalent cations including calcium and/or magnesium carbonate. The step of causing the carbonate of the divalent cation to precipitate may comprise adding a nucleating agent to the brine. The nucleating agent may be capable of facilitating the formation of calcite and/or dolomite and/or magnesite, such that addition of the nucleating agent causes calcite and/or dolomite and/or magnesite to precipitate from the brine. Suitable nucleating agents include limestone, calcite, dolomite, vaterite, clay minerals, purified bovine carbonic anhydrase, purified human carbonic anhydrase, calcium oxalate, sodium carbonate, porphyrin amphiphiles, magnetic fields, proteins, sodium oleate and a range of natural poorly defined soap compounds including sapo animals (curd soap), sap durus (hard shap) and sap mollis (soft soap), as well as combinations of any two or more of these.

Following the precipitation of the carbonate of the divalent cation, it may be collected and disposed of. The disposing may comprise burying, or locating in a waste dump, or may comprise optionally purifying, packaging and/or sale.

The process may comprise the step of providing the halide of the divalent cation, for example by a process described earlier in this specification. Thus the process of providing the halide of the divalent cation may comprise:

(a) reacting a carbonate, oxide or hydroxide of the divalent cation with carbon dioxide and water and/or with a species resulting from the dissolution of carbon dioxide in water, to form a hydrogen carbonate of the divalent cation;

(b) exchanging the divalent cation of the hydrogen carbonate of the divalent cation formed in (a), using an ion exchange medium, for the monovalent cation to produce a solution of a hydrogen carbonate of the monovalent cation; and

(c) regenerating the ion exchange medium with a halide of the monovalent cation or with a hydrohalic acid to produce the halide of the divalent cation.

wherein said carbonate, oxide or hydroxide of the divalent cation has a low solubility in water.

Accordingly, in one embodiment, the process comprises:
reacting a carbonate, oxide or hydroxide of a divalent cation with carbon dioxide and water and/or with a species resulting from the dissolution of carbon dioxide in water, to form a hydrogen carbonate of the divalent cation;
exchanging the divalent cation of the hydrogen carbonate of the divalent cation thus formed, using an ion exchange medium, for a monovalent cation to produce a solution of a hydrogen carbonate of the monovalent cation;
regenerating the ion exchange medium with a halide of the monovalent cation or with a hydrohalic acid to produce a halide of the divalent cation;
adding the halide of the divalent cation to a body of supersaturated carbonate-containing brine which is in contact with a CO₂-containing atmosphere so as to cause the halide of the divalent cation to form a carbonate of the divalent cation, said carbonate having low solubility; and
causing the carbonate of the divalent cation to precipitate from the body of carbonate containing brine;
   wherein the carbonate, oxide or hydroxide of the divalent cation has a low solubility in water.

In another aspect of the invention there is provided an apparatus for the sequestration of carbon dioxide, comprising:
a contactor for contacting a halide of a divalent cation to a body of supersaturated carbonate-containing brine which is in contact with a carbon dioxide containing gas so as to cause the halide of the divalent cation to form a carbonate of a divalent cation, which precipitates from the body of carbonate-containing brine, said carbonate having low solubility; and
a separator for separating the carbonate of the divalent cation from the body of carbonate-containing brine.

The apparatus may additionally comprise one or more of:
a nucleator for adding a nucleating agent to the brine, so as to cause calcite and/or dolomite and/or magnesite and/or sodium carbonate phases to precipitate from the seawater; and
an evaporator, e.g. a canal, for evaporating water from the brine.

In an embodiment, there is provided an apparatus for the sequestration of carbon dioxide, comprising:

(a) a bicarbonator reactor for reacting a carbonate of a divalent cation with the carbon dioxide and water and/or with a species resulting from the dissolution of the carbon dioxide in water, to form a hydrogen carbonate of the divalent cation wherein said divalent cation is capable of forming a carbonate that has a low solubility in water; and

(b) an ion exchange medium for exchanging the divalent cation of the hydrogen carbonate formed in the bicarbonator reactor for a monovalent cation to produce a hydrogen carbonate of the monovalent cation.

(c) an ion exchange medium regenerator for regenerating the ion exchange medium with halide of the monovalent halide or with a hydrohalic acid to produce a halide of the divalent cation

(d) a contactor for contacting the halide of the divalent cation to a body of supersaturated carbonate-containing brine which is in contact with a carbon dioxide containing gas so as to cause the halide of the divalent cation to form a carbonate of the divalent cation, which precipitates from the body of carbonate-containing brine, said carbonate having low solubility;

(e) an evaporator for evaporating water from the brine; and

(f) a separator for separating the carbonate of the divalent cation from the body of carbonate-containing brine.

### BRIEF DESCRIPTION OF THE DRAWINGS

Embodiments of the invention will now be described with reference to the accompanying drawings, in which:

FIG. 1 is a schematic of a process according to a first embodiment of the invention;

FIG. 2 is a sketch of the bicarbonation step of FIG. 1;

FIG. 3 is a sketch of the ion exchange step of FIG. 1;

FIG. 4 is a sketch of a first version of a drying step of FIG. 1;

FIGS. 5A and 5B are plan and elevation views of a second dryer arrangement;

FIG. 6 is a schematic of a process according to a second embodiment of the invention; including CO₂ generation and alternative drying steps;

FIG. 7 is a sketch of the CO₂ generator;

FIG. 8 is a diagrammatic process flow sheet of a third embodiment of the invention in which carbon dioxide is sequestered in more than one step;

FIG. 9 is a sketch of a solar pond system adapted for fractional crystallization and recovery of salts from seawater;

FIG. 10 shows three different examples (scenarios) of plant location for an apparatus according to the present invention;

FIG. 11 shows a diagrammatic illustration of an apparatus for sequestering carbon dioxide according to the present invention; and

FIG. 12 shows diagrammatic illustration of another apparatus for sequestering carbon dioxide according to the present invention.

### DETAILED DESCRIPTION OF THE DRAWINGS

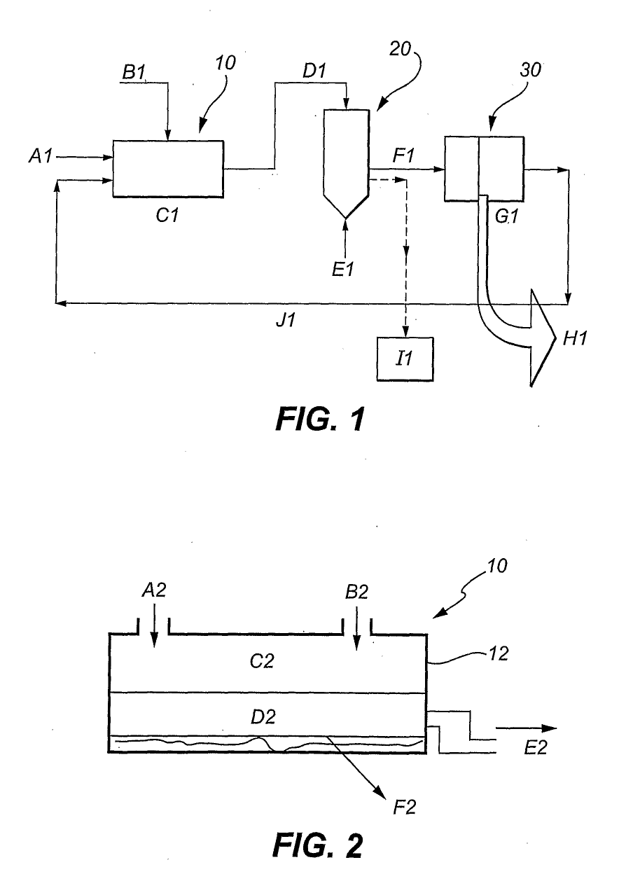

With reference to FIGS. 1 and 2, solid phase calcium and/or magnesium carbonate, water and a gas containing CO₂ are fed at ambient temperature to a bicarbonator reactor comprising a tank 12 in which the solid carbonate is held in contact with the water, and the water is contacted with the CO₂ containing gas in accordance with step (a) of the process according to the first aspect of the invention.
A1 represents CaCO₃ or MgCO₃
B1 represents CO₂
C1 represents Calcium Carbonate Bicarbonator
D1 represents Ca(HCO₃)₂ or Mg(HCO₃)₂
E1 represents ion exchange zeolite
F1 represents NaHCO₃
G1 represents Dryer
H1 represents NaHCO₃ to evaporation pans
I1 represents CaCl₂
J1 represents CO₂ recycled
A2 represents CO₂ from CO₂ generator
B2 represents CO₂ from dryer
C2 represents CO₂(g) 100%
D2 represents Ca(HCO₃)₂(aq)
E2 represents Ca(HCO₃)₂ to ion exchanger
F2 represents CaCO₃ (s)
A3 represents Ca(HCO₃)₂ or Mg(HCO₃)₂
B3 represents “Sealed to maintain pure CO₂ atmosphere”
C3 represents “Naturally occurring Aluminosilicate Minerals”
D3 represents NaHCO₃ to dryer
E3 represents “Regeneration eluate to evaporation ponds, CaCl₂ or MgCl₂”

In step (a), the CO₂ partial pressure is of preferably more than 1 atmosphere.

After reaction, the calcium and/or magnesium (or cationic) hydrogen carbonate (or carbonate) solution produced by step (a) is fed to the ion exchange step 20, where it is contacted with an ion exchange medium or exchange of the cations for sodium ions, in accordance with any one or more of equations 15 to 18.

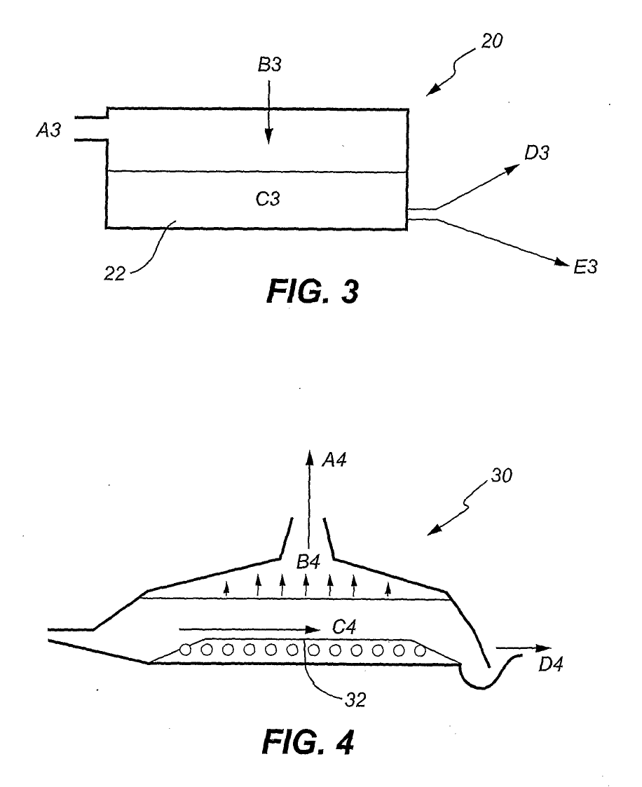

FIG. 3 is a sketch of a suitable ion exchange reactor, which may consist simply of a horizontal bed 22 of the ion exchange medium, through which the cationic hydrogen carbonate solution is passed. Alternatively, the ion exchange reactor may consist of a column or tube reactor or other reactor types known in the art.

The ion exchange is preferably conducted at ambient temperature. The ion exchange reactor is preferably sealed to prevent escape of any CO₂ dissolved in the feed solution.

During ion exchange, the calcium or magnesium ions are taken up by the ion exchange medium, in exchange for sodium ions, so that sodium hydrogen carbonate solution is produced. Regeneration of the ion exchange medium is performed by pumping a concentrated sodium halide solution through the bed, the medium taking up the sodium ions and releasing the calcium or magnesium ions in the form of a calcium or magnesium halide solution.

Preferred ion exchange media are those which can be regenerated directly with sodium halide solution, preferably NaCl, without requiring an intermediate acid regeneration step. Suitable ion exchange media include natural aluminosilicate ion exchange media, such as zeolites or clays. It will be understood that, although these preferred ion exchange media may not require acid regeneration at each regeneration it may still be necessary occasionally to regenerate the medium with dilute HCl when the ion exchange capacity of the medium decreases.

The NaHCO₃ solution produced by the ion exchange step may be pumped directly into solar evaporation pans to produce solid phase sodium bicarbonate for sale.

Optionally, the solution may first pass through a dryer 30, shown in FIG. 4. in which the solution is passed over a plate 32 heated by hot water to drive dissolved CO₂ out of solution into the gas phase. The CO₂ is then removed, cooled and recycled into the CO₂ feed for the bicarbonator 10. The CO₂-depleted solution from the dryer can then be released to the evaporation pans as described above. A4 represents “to bicarbonator after cooling”; B4 represents CO₂; C4 represents flow direction and D4 represents “to evaporation pans”.

An aim of the process is to produce little or no CO₂ emissions, so that the net carbon uptake by the process, and therefore carbon credits, is maximised. Without the dryer step 30, some CO₂ will be emitted due to dissolved CO₂ in the sodium hydrogen carbonate solution from the ion exchange bed. The desirability or otherwise of including the dryer 30 will thus depend on comparison of the amount of recoverable CO₂ against the power requirements and power source for the dryer. It is anticipated that the present process will be most suited for desert environments. where both land space and solar power are plentiful, and thus the dryer step will often be beneficial.

The calcium or magnesium halide produced during regeneration of the ion exchange medium is a most valuable product of the present process, as it may be used for the long term sequestration of atmospheric CO₂ as will be described below.

The carbonates of both calcium and magnesium are relatively insoluble in water present process, the calcium or magnesium halide (preferably chloride) may he added to an open tank or pond of pre-treated seawater, reacting with dissolved CO₂ (in the form of carbonic acid, H₂CO₃) in the seawater to form a precipitate of the respective carbonate. The consequent depletion of dissolved CO₂ in the seawater causes transfer of atmospheric CO₂ across the air/water interface to seek to attain CO₂ equilibrium between the air and water. The net result is that atmospheric CO2 is removed and locked up in the solid phase as calcium or magnesium carbonate, which can readily be removed by scraping from the bottom of the tank or pond. Calcium carbonate s a stable mineral which can be disposed of underwater, for example in the deep ocean, with minimal environmental effect. Disposal of magnesium carbonate in seawater will cause reaction, over time, to calcium carbonate or calcium carbon/magnesium carbonate blends such as dolomite.

The sea water used for the CO₂ sequestration step is pre-treated by filtration to remove phosphates and organics. Suitable filtration media include bentonite clay or 0.45 μm filter medium, which can be regenerated as required by treatment with dilute acid.

As an alternative to the seawater in the sequestration step, any brine having elevated calcium or magnesium carbonate concentration may be used. It is believed that some groundwaters, such as some artesian waters, will be well suited for this purpose.

It is therefore believed that, in addition to the production of sodium hydrogen carbonate, which has commercial value in its own right and can also be used as a precursor for production of other compounds, the process can achieve the long term sequestration of atmospheric CO₂ while itself operating at ambient temperature an pressure and resulting in little or no CO2 emission and thus be eligible for carbon credits which are a valuable economic commodity.

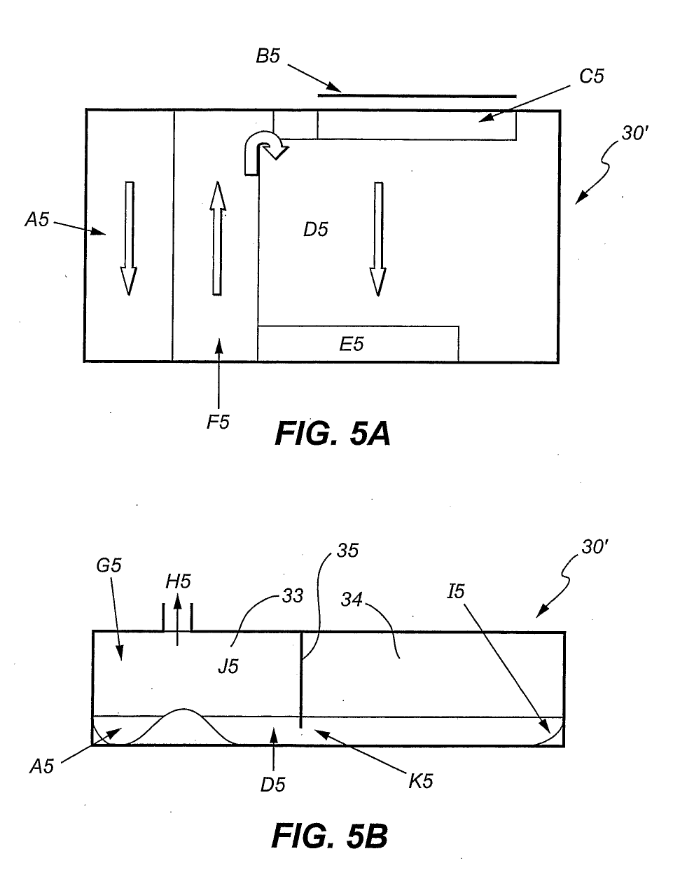

FIGS. 5A and 5B are, respectively, plan and elevational views of an alternative drying arrangement 30′, in which the sodium hydrogen carbonate solution is passed counter current to a stream of concentrated H₂SO₄ (93%) in a polypropylene or other acid resistant vessel. The vessel has a closed gas space 33 in contact with both the solon and the acid streams, whereby the acid picks up water vapour from the headspace above the sodium hydrogen carbonate solution. The CO₂ in the headspace is recycled to the bicarbonator 10. The acid stream returns via a partially enclosed chamber 34 separated from the sealed headspace by weir 35, where it is heated to drive off water vapour and cooled again before returning to the countercurrent area,
A5 represents NaHCO₃(aq)
B5 represents fans
C5 represents heat exchanger
D5 represents H₂SO₄
E5 represents cooling
F5 represents H2 SO₄ (conc) (Less than 93% H₂SO₄)
G5 represents “sealed to prevent CO₂ escape”
H5 represents “CO₂ to step 2”
I5 represents polypropylene basin
J5 represents H₂O
K5 represents “projects into H₂SO₄ to prevent CO₂ escape”

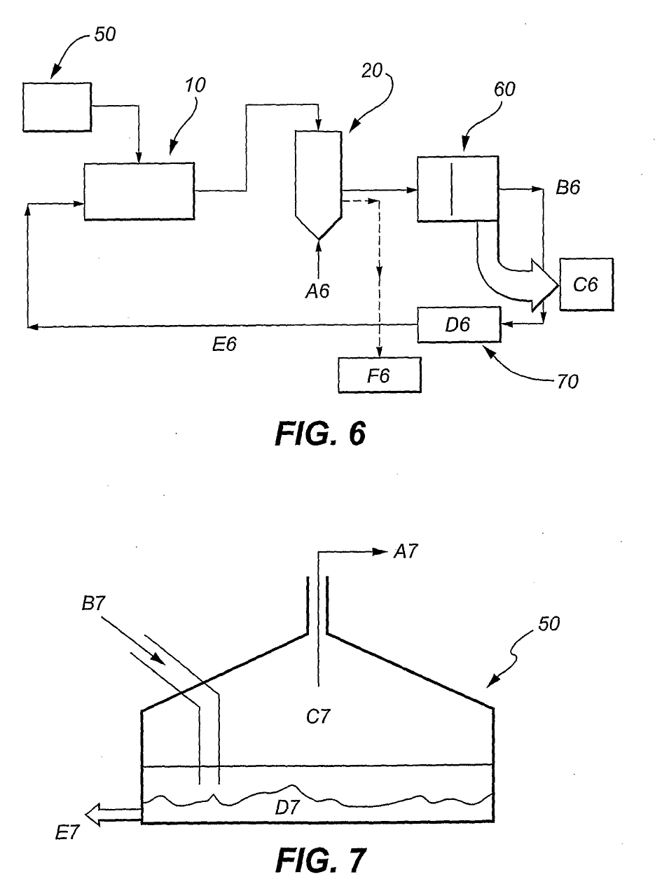

FIGS. 6 and 7 illustrate an alternative form of the process. In addition to the bicarbonator 10 and ion exchange reactor 20, which operate as described above, the process of FIGS. 5 to 6 further includes a CO₂ generator 50, and a modified dryer 60 and recycling process.
A6 represents ion exchange resin/zeolite
B6 represents Na₂SO₄
C6 represents Na₂SO₄(aq) waste
D6 represents cooler
E6 represents “CO₂ recycled, CaCO₃ recycled”
F6 represents “CaCl₂+salt water to form CaCO₃”
A7 represents “to bicarbonator”
B7 represents HCl
C7 represents CO₂
D7 represents CaCO₃
E7 represents CaCl₂(aq)

The CO₂ generator 50, shown in FIG. 7, consists of a reaction vessel in which calcium or magnesium carbonate is contacted with acid to produce CO₂ gas, for example as follows:

CaCO₃+2HC1→CaCl₂(aq)+CO₂(g)+H₂O (21)

The CO₂ generator 50 is operated only as required to start the process and to supplement the CO₂ recycle stream from the dryer 60 (described below). The CO₂ output from the generator 50 may be piped directly to the bicarbonator 10, which operates as described for the first embodiment of the invention, or may be collected, and stored for subsequent use.

The ion exchange reactor 20 also operates generally as described above for the first embodiment.

The second embodiment illustrated in FIG. 6 incorporates an alternative dryer arrangement 60, in which the sodium hydrogen carbonate is reacted with calcium sulphate with heating to form sodium sulphate and CO₂, as follows:

2NaHCO₃(aq)+CaSO₄(s)+CaCO₃, H₂O+Na₂SO₄(aq)+CO₂(g) (22)

The sodium sulphate solution thus produced is passed through cooler 70, and both the sodium sulphate and the CO₂ recycled to the bicarbonator 10. Recycling of the sodium sulphate is continued until the Ca²⁺:ratio reaches about 1:4, at which point the ion exchange step will no longer occur. The resultant solution is then dried by heating or with sulphuric acid to form a sodium sulphate slurry which is then released to evaporation pans for recovery and sale. This embodiment minimises the carbon dioxide emission to the atmosphere.

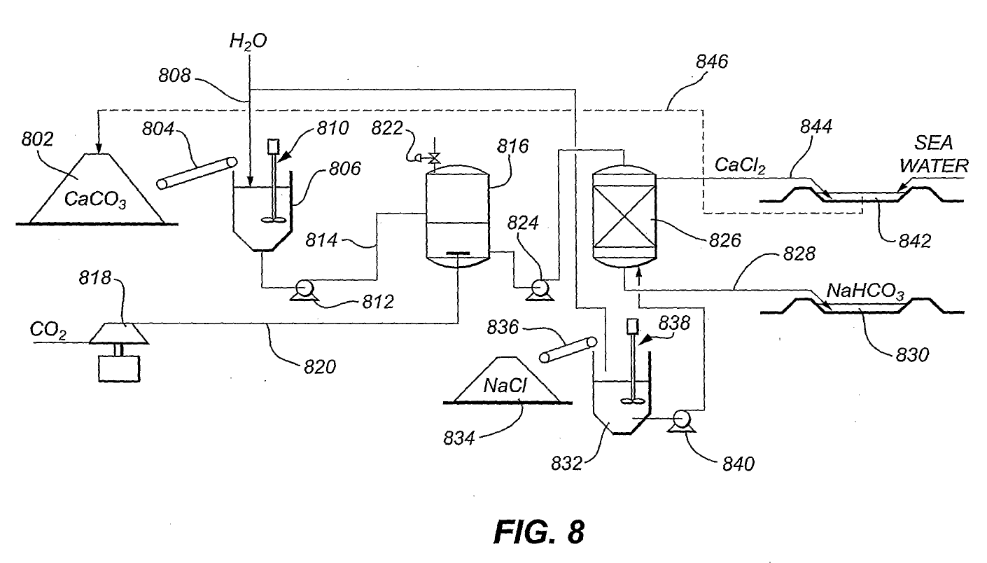

Referring now to FIG. 8, there is shown a diagrammatic process flow sheet of the process in accordance with the invention, in which carbon dioxide is sequestered in more than one step. In the process, calcium carbonate in the form of crushed lime 802 is periodically conveyed by a conveyer 804 to a slurry preparation tank 806 where the crushed lime is mixed with fresh water into the slurry preparation tank 806, by a line 808. To prepare the slurry, a mixer 810 is used.

From the slurry preparation tank 806, the slurry is pumped by means of a slurry pump 812 via a slurry line 814 to a bicarbonation reactor 816. In the bicarbonation reactor 816, carbon dioxide is contacted with the slurry. The carbon dioxide is introduced into the bicarbonation reactor 816 by means of a compressor 818 and a carbon dioxide line 820. The bicarbonation reactor 816 is maintained under pressure by means of a pressure control valve 822.

The bicarbonation reaction in the bicarbonator reactor 816 may be conducted either batchwise or continuously.

After bicarbonation, the resultant calcium bicarbonate solution is transferred by means of a transfer pump 824 to an ion exchange column 826 which is packed with a suitable ion exchange resin such as Chelex 1000™ or suitable zeolite either natural or synthetic and/or suitable clay-mineral product. In the ion exchange column 826, the calcium bicarbonate solution exchanges calcium cations for sodium cations so that the solution becomes a solution of sodium bicarbonate which exits the ion exchange column 826 at its bottom via a line 828, which conveys the sodium bicarbonate to a solar evaporation pond 830 where the solution is evaporated until sodium bicarbonate crystallizes from the resulting bittern.

When the ion exchange resin in the ion exchange column 826 has exchanged all or most of its sodium ions for calcium ions, it needs to be regenerated.

In order to regenerate the ion exchange resin of the ion exchange column 826, a solution of salt is prepared in a salt preparation tank 832. In the salt solution preparation tank 832, salt from storage 834 is transferred by means of a conveyer 836 to the salt solution preparation tank 832. In order to facilitate the dissolution of the salt in the salt solution preparation tank 832, a mixer 838 is employed. The salt solution is pumped to the ion exchange column 826 by means of a brine pump 840. The ion exchange resin in the ion exchange column 826 is regenerated with the brine solution. Sodium cations are exchanged for calcium cations, with the result that the solution exiting from the ion exchange column 826 contains calcium chloride. This solution is transferred to a solar evaporation pond 842 via a calcium chloride line 844. Prior to transferring the calcium chloride solution to the solar evaporation pond 842, seawater is pumped into the solar evaporation pond 842. When the calcium chloride solution is added to the seawater in the solar evaporation pond 842, calcium carbonate precipitates from it. This calcium carbonate precipitate may be recycled to the calcium carbonate (or lime) storage 802, by means of a calcium carbonate recycle line 846.

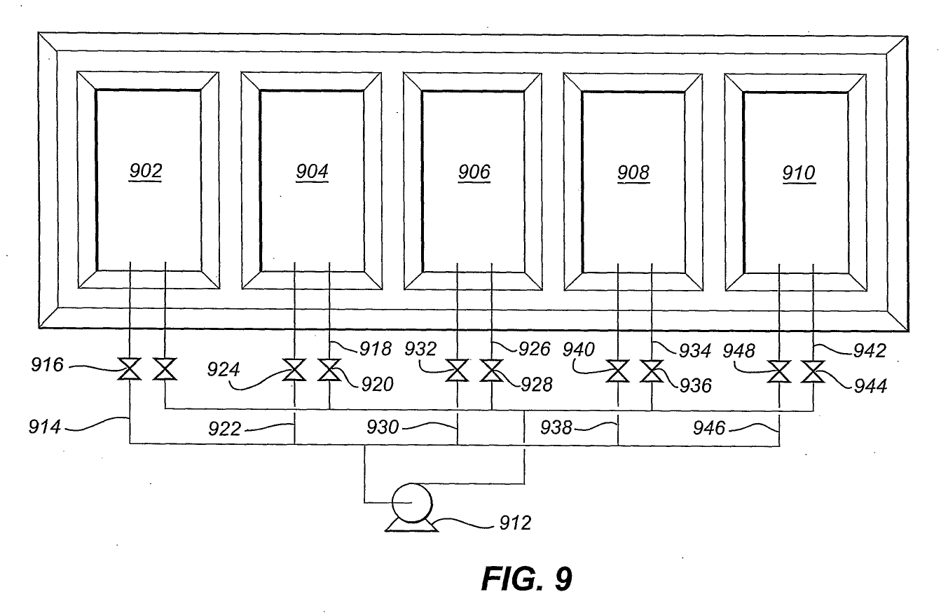

Referring now to FIG. 9, there is shown a series of five solar evaporation ponds respectively designated 902, 904, 906, 908 and 910. The solar evaporation pond 902 may be the same as the solar evaporation pond 842 of FIG. 8.

By adding calcium chloride to the seawater in the solar evaporation pond 902, calcium carbonate may be caused to precipitate. The precipitation of calcium carbonate may be enhanced by evaporation of water from the solar evaporation pond 902.

Before any calcium or magnesium compounds other than calcium or magnesium carbonate precipitate from the seawater, it may be transferred, by means of a transfer pump 912 from the solar evaporation pond 902 to the solar evaporation pond 904, using a suction line 914 and opening a suction valve 916, discharging into the solar evaporation pond 904 through a discharge line 918, with a discharge valve 920 being in its open position. Similarly, the seawater may be transferred, after crystallization in the solar evaporation pond 904 to the solar evaporation pond 906, using the transfer pump 912 to suck water from the solar evaporation pond 904, using a suction line 922 and opening a suction valve 924 therein, discharging into the solar evaporation pond 906 through a discharge line 926, with a discharge valve 928 therein being in its open position, and so forth. Thus, after crystallization in the solar evaporation pond 906, the seawater may be transferred to the solar evaporation pond 908, using the transfer pump 912 to suck water from the solar evaporation pond 906, through a suction line 930 and opening a suction valve 932 therein, discharging into the solar evaporation pond 908 through a discharge line 934, with a discharge valve 936 therein being in its open position. Lastly, after crystallization in the solar evaporation pond 908, the seawater may be transferred to the solar evaporation pond 910, using the transfer pump 912 to suck water from the solar evaporation pond 908, through a suction line 938 and opening a suction valve 940 therein, discharging into the solar evaporation pond 910 through a discharge line 942, with a discharge valve 944 therein being in its open position.

In this way, consecutive crystallization steps may be caused to take place in the solar evaporation ponds 902, 904, 906, 908 and 910 so that separate products may be recovered from seawater such as CaCO₃, NaHCO₃, Na₂CO3, CaMg(CO₃)₂, Mg(OH)₂ MgCO₃ and Ca(OH)₂.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein. It will further be understood that any reference herein to known prior art does not, unless the contrary indication appears, constitute an admission that such prior art is commonly known by those skilled in the art to which the invention relates.

In this specification, the word “comprising” is to be understood in its “open” sense that is, in the sense of “including”, and thus not limited to its “closed” sense, that is the sense of “consisting only of”. A corresponding meaning is to he attributed to he corresponding words “comprise”, “comprised” and “comprises” where they appear.

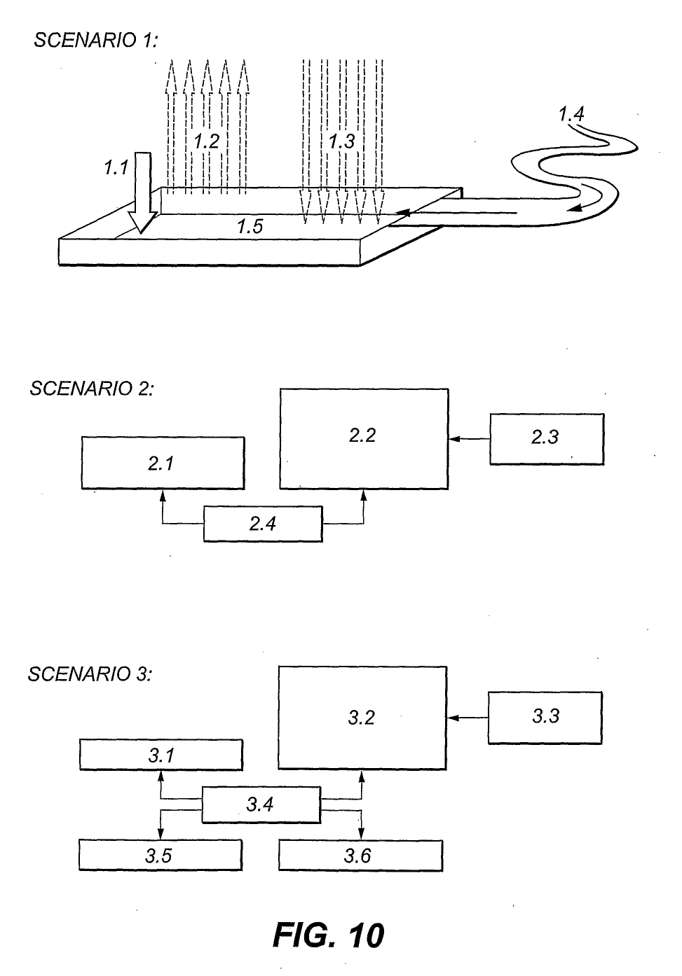

FIG. 10 shows three different examples (scenarios) of plant location for an apparatus according to the present invention.

With reference to Scenario 1 of FIG. 10, seawater enters the canal at a salinity of approximately 35 ppt or slightly higher. During travel along the sinuous canal it gradually evaporates and becomes slightly more saline. The optimum flow rate of the canal has been modelled to be most likely in the range of 0.5 to 2.0 km/hour under climatic conditions where pan evaporation rates are approximately 3 times total precipitation with humidities generally less than 50%. The ambient shade air temperatures modeled have been in the range of 25° C. to 35° C. although direct sun temperatures may be as high as 60° C. The model relates to situations where there are in excess of 300 days per year when there are more than 8 hours of sunshine per day. Also, the number of days where precipitated unambiguously exceeds pan evaporation is usually less than 20 days per year. That is, the model is best suited to the Savanna-style of semi-arid monsoonal tropics. With modifications, the model can be extended to more classical Mediterranean styles of climatic regime.

Other models at flow rates in the range of 0.1 to 10 km/hour have also been modelled to a preliminary stage, but rates of 0.5 to 2.0 km/hour are believed to be more efficient with respect to yield rates. Thus the flow rate may be between about 0.1 and 10 km/hour, or between about 0.1 and 5, 0.1 and 2, 0.1 and 1, 0.5 and 10, 1 and 10, 2 and 10, 5 and 10, 0.5 and 5, 0.5 and 2, 0.5 and 1 or 1 and 2 km/hour, e.g. about 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5 or 10 km/hour, or some other value, descending on the evaporation rate, direct sun temperature, days of sun, hours of sun per day and other factors.

Under tropical Savanna-style climates, after a traverse along the canal of 12 to 24 km, the saline water has achieved a salinity in the range of 39 to 42 ppt. At this point, which is site and time specific, the gently flowing water is treated by injection of a compatible divalent halide or divalent hydroxide solution and of an appropriate nucleating agent. Crystals of the carbonate begin to form. In Mediterranean style of climates lengths of the sinuous canal required may be up to 80 km.

The divalent halide may be produced from the corresponding divalent bicarbonate using an ion exchange medium to convert the ion exchange medium to the divalent ion form, followed by regeneration of the ion exchange medium with a monovalent halide. This may be accomplished using ion exchange plant not shown in FIG. 10.

### In FIG. 10:

Scenario 1 shows a simple atmospheric exchange plant;
Scenario 2 shows a coastal location—all plant at one location;
Scenario 3 shows plant and tunnel located kilometres apart.
1.1 represents precipitation (e.g. NaHCO₃; CaCO₃)
1.2 represents evaporation
1.3 represents CO₂ (atmosphere)
1.4 represents sinuous flow-through canal system to evaporation pond
1.5 represents pond (30 or 100 ha)
2.1 represents bicarbonator and Pond-Greensols P/L
2.2 represents electrostatic precipitator/wet tunnel technology
2.3 represents agglomerator technology
2.4 represents “connected”
3.1 represents Pond-Greensols P/L
3.2 represents electrostatic precipitator/wet tunnel technology
3.3 represents agglomerator technologies
3.4 represents ‘x’ kms separation
3.5 represents coastal location
3.6 represents inland location

The crystallization may either continue in the flow canal itself or occur in a largely static/gently agitated pond through which the water flows at a very low flow rate. In this pond further slight evaporation occurs and crystallization may be promoted by use of suitable structures (e.g. concrete pillars). Alternatively, the crystals may be allowed to fall to the floor of the pond prior to regular draining and harvesting.

In order to limit the extent of the reaction and to maintain the general chemical properties of the slightly evaporated sea-water, the flow minus the settled crystals is allowed to exit the pond at a low flow rate. Residence times in the pond of the order of 1 to 10 days are envisaged depending on climatic conditions and specific product. Such a gentle flow ensures that the conditions for crystallization remain favourable and that there is sufficient time for carbon dioxide from the atmosphere to dissolve in the supernatant solution in order to attempt to regain, approximately, the supersaturation and metastable conditions of normal seawater. Experimentally and inferentially, it has been found that, even after the precipitation of reasonable amounts of the divalent carbonate solid phase, bicarbonate levels in the exiting solution are very similar to those of the starting solutions. The only source of this balancing carbon dioxide is the atmosphere.

Thus, the process is regarded as the crystallization of a divalent carbonate accompanied and followed by the one-way exchange of carbon dioxide from the atmosphere. The kinetics of this exchange are such that a residence time in the pond needs to be in the range 1 to 10 days. The exiting solution is very similar in composition to that of a slightly concentrated seawater of 42 ppt with calcium levels slightly lower than would be expected and bicarbonate at normal levels.

With reference to Scenario 2 of FIG. 10, where the plant is close to a coal-fired power station near the ocean, the carbon dioxide stream from the flue gas enters an agglomerator in order to aggregate small particles, less than 2.0 um in size, into larger particles. These particles are then removed, together with those of an initial size greater than 2.0 um in size, by use of technologies such as electrostatic precipitators and/or wet tunnels. These particles are removed as they generally are quite acidic and are able to impart a high degree of acidity to the seawater used in the next stage of the process. This acidity will ultimately totally disrupt the carbonate precipitation process. The carbon dioxide flue gas stream, less its entrained particles, is then passed into a pond or canal system as already described.

With reference to Scenario 3 of FIG. 10, where a coal-fired power station is remote from the ocean, the flue gas stream of carbon dioxide can be treated by agglomerator, electrostatic precipitator and/or wet tunnel technologies as above. In this case the cleaned carbon dioxide stream escapes to the atmosphere. However, at a normal canal/pond system many kilometers from the power station and near the ocean, an equivalent or greater amount of carbon dioxide may be sequestered from the atmosphere in compensation for that emitted at the power station.

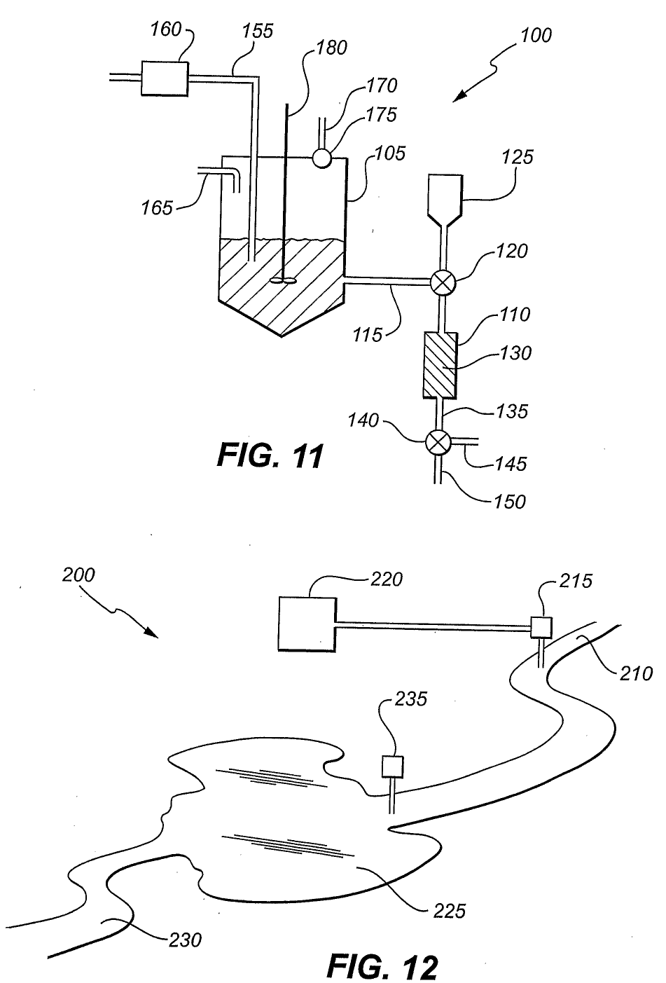

FIG. 11 illustrates apparatus 100 for sequestering carbon dioxide as described in the present specification. Apparatus 100 comprises bicarbonator reactor 105 for reacting a carbonate of a divalent cation with the carbon dioxide and water and/or with a species resulting from the dissolution of the carbon dioxide in water. Reactor 105 is connected to ion exchanger 110 by pipe 115, which is fitted with valve 120. Valve 120 allows either hydrogen carbonate solution from reactor 105 or regeneration solution from tank 125 to pass to ion exchanger 110 as required. Ion exchanger 110 contains ion exchange medium 130, which contains ion exchange medium 112. Output from ion exchanger 110 passes through pipe 135, and is directed by valve 140 either to calcium chloride output 145 (when regenerating medium 130) or to hydrogen carbonate output 150 (when ion exchanging). Output 150 may be connected to an evaporator (not shown) for evaporating the hydrogen carbonate solution from ion exchanger 110 to produce solid sodium carbonate. Thus the system comprises an ion exchange medium regenerator for regenerating the ion exchange medium which comprises tank 125, valves 120 and 140 and output 145.

Bicarbonator reactor 105 has entrance port 155 for admitting a carbon dioxide containing gas, for example for admitting exhaust gas, flue gas, fermentation gas, cement and lime calciner off-gas, or some other carbon dioxide containing gas. Entrance port 155 is fitted with electrostatic precipitator 160 for removing particles from the carbon dioxide containing gas to prevent them from entering bicarbonator reactor 105. Bicarbonator reactor 105 also has water inlet 165 for admitting water to the reactor, and also has a carbonate port (not shown) for allowing calcium carbonate to be added to bicarbonator reactor 105. Bicarbonator reactor 105 is also fitted with exit port 170, to allow gas from which the carbon dioxide has been sequestered to exit reactor 105. Exit port 170 is fitted with pressure regulator 175 for controlling the pressure inside bicarbonator reactor 105 between about 1.1 atm and about 10 atm.

Bicarbonator reactor 105 also is fitted with agitator 180 for agitating an aqueous slurry of calcium carbonate within reactor 105.

In operation, a carbon dioxide containing gas enters apparatus 100 through electrostatic precipitator 160, which removes particles from the gas which might otherwise affect the pH within reactor 105, which is an enclosed chamber. The gas then passes into reactor 105 through pipe 155. Also, when necessary, water is added to reactor 105 through water inlet 165. Reactor 105 contains a slurry of calcium carbonate in water, which may be agitated if required using agitator 180. When the carbon dioxide containing gas contacts the slurry, the calcium carbonate reacts with the carbon dioxide and water and/or with a species resulting from the dissolution of the carbon dioxide in water, to form calcium hydrogen carbonate solution. Waste gas passes out of reactor 105, through port 170, and the pressure within reactor 105 is controlled to the desired pressure by pressure controller 105. The calcium hydrogen carbonate solution passes through pipe 115 and valve 120 to ion exchanger 110, which contains ion exchange medium 130 in the sodium form. By passing through ion exchange medium 130, calcium ions are exchanged for sodium ions to form a sodium hydrogen carbonate solution, which passes out of ion exchanger 110 through pipes 135 and 150 and valve 140. This progressively converts ion exchange medium 130 from the calcium form to the sodium form. If required, the sodium hydrogen carbonate solution may be evaporated to produce solid hydrogen carbonate, which may be used, packaged and/or sold with or without further purification.

Ion exchange medium 130 may be regenerated to the sodium form using the ion exchange medium regenerator. In this process, valve 120 is set so as to allow sodium chloride from tank 125 to pass through ion exchanger 110, and valve 140 is set to allow the resulting calcium chloride to pass through pipes 135 and 145. The calcium chloride solution may be stored or used as required.

FIG. 12 shows another apparatus for the sequestration of carbon dioxide according to the present invention. In FIG. 12, apparatus 200 comprises canal 210, which brings seawater into the apparatus and serves as an evaporator. Canal 210 maybe up to about 80 km long, and has a large surface area for evaporating water from seawater to generate supersaturated brine. It also serves as a dissolver for dissolving carbon dioxide from the atmosphere. Apparatus 200 also comprises contactor 215 for contacting the supersaturated carbonate-containing brine in canal 210 with calcium chloride solution. The calcium chloride solution is obtained from calcium chloride source 220, which may be for example an apparatus as shown in FIG. 11, functioning as a calcium chloride generator, or may be a tank of calcium chloride solution. Canal 210 feeds pond 225, which is capable of acting as a separator for separating solids from the liquid therein, by settling. Pond 225 may contain structures (not shown), for example concrete or metal structures, pillars etc., to facilitate precipitation and/or separation of solids. The structures may be removable from pond 225. Pond 225 has output channel 230 for removing brine from pond 225. Canal 210 also is fitted with nucleator 235 for adding a nucleating agent to the liquid in canal 210 so as to cause, or facilitate, precipitation of calcite and/or magnesite from the brine.

In operation seawater passes from the sea into canal 225. As it passes down the canal, the seawater loses water by evaporation, and also dissolves additional carbon dioxide, to generate a supersaturated carbonate containing brine. Calcium chloride from source 220 is added to the brine by means of contactor 215. A nucleating agent, such as powdered limestone, is added to the brine by means of nucleator 235 in order to facilitate precipitation of carbonates, although precipitation of all or part of the carbonates may occur prior to or in the absence of nucleation, either in canal 225 downstream of contactor 215 or in pond 225. The brine passes into pond 225 where precipitation and settling of carbonates occurs. The brine then passes out of pond 225 through channel 230, and may be returned to the sea. If structures are present in pond 225 to facilitate precipitation and/or separation of solids, they may be removed intermittently, and solids which have adhered thereto may be removed.

Carbonates precipitated in pond 225 may be collected (for example by draining pond and collecting the collected sludge) and disposed of. The disposing may comprise burying, or locating in a waste dump, or may comprise optionally purifying, packaging and/or sale.

### Example

In this section the following are universally applicable:
Seawater was collected from Cleveland Bay, Townsville, Queensland close to the sea water inlet for the aquaria of the Great Barrier Reef Marine Park Authority.
The sea water always was filtered through a 0.45μ synthetic filter.
All chemicals used were of ANALAR grade.
All solids produced were examined using powder X-ray diffraction techniques.
Where applicable semi-quantitative proportions of the solid phases present were determined by using calibrated peak area techniques and/or Reitveld techniques via the SIROQUANT program.
Where appropriate chemical modelling of the input and exit solutions were undertaken using either or both WATEQF4 or PHREEQC chemical speciation programs.
A range of analytical chemical techniques were employed including:
   Atomic absorption spectrophotometry
   Inductively coupled plasma mass spectrometry
   Standard water quality titration, selective ion electrode and gravimetric techniques

### Procedure:

Seawater was collected in 20 litre plastic containers. These containers had previously been acid washed using Analar hydrochloric acid, rinsed with distilled water and triply washed with ambient sea-water immediately prior to collection. The seawater was then doubly filtered in the laboratory through 0.45 μm, polycarbonate filters fitted to a vacuum suction system, and then stored at approximately 25° C. in a darkened room until used.

All experiments were carried out at a room temperature of approximately 25° C. under clean conditions. Analytical grade (Analar) chemicals were used to make up all solutions for the experiments. These were made up to appropriate concentrations with weights being determined on a four decimal place figure analytical balance with compounds being dried, if appropriate, at 105° C. for approximately 24 hours. Any crystalline hydrates used were used in an off-the-shelf condition since drying may not produce a consistent stoichiometry. All solutions were made up in atmospherically equilibrated distilled water. Deionised water containing deionising resins is known to inhibit some crystallization reactions and processes. Analytical grade chemicals were used as it is known that ordinary reagent grade chemicals may contain some impurities that may inhibit or enhance crystallization reactions. Although Analar grade chemicals may contain similar impurities they are generally at lower concentrations than in Lab-Grade reagents. The effects of Analar grade materials are known to be less than those of Lab-grade materials. Specpure Grade materials are known to be superior in performance to Analar grade chemicals but these are prohibitively expensive to use in large amounts.

Solutions of all reactants were made up in either suitably washed plastic bottles or in volumetric analysis flasks as appropriate. Ranges of concentrations were used according to different experimental requirements. Prior to use all reactants were doubly filtered through 0.45 μm polycarbonate filters. This was to remove any solid material of size greater than 0.45 um that may be present in these solutions. These solids have the potential to act as centres of heterogeneous nucleation and thus affect experimental results.

Experiments were undertaken in a variety of reaction vessels as available. These were usually clean plastic bottles, plastic jars, plastic home brewing containers up to a volume of 200 L. Occasionally clean glass reaction flasks were used. Most experiments were carried out in plastic vessels in the 10 to 20 L range. This size is convenient to provide a suitable amount of solid for further studies. For convenience results are presented either as grams/200 L or grams per litre basis.

Samples of all solutions were taken immediately prior to reaction in order to establish the starting compositions of the solutions.

Each reaction experiment was carried out in duplicate.

Reactions were allowed to proceed for varying lengths of time up to 1 week. Experiments were undertaken either under static conditions or under continuous agitation on a vibrating table. At the end of the experiment all contained solids produced were put into suspension and the liquid filtered through 0.45 μm filters until judged by eye to be clear. The crystalline solid produced was then dried for further analysis. Additionally, samples of the remaining clear solution were sampled for analysis of a range of analytes so that the finishing composition of each reacted solution.

A range of analytical techniques were use to assess solution chemistry. These included atomic absorption spectrophotometry, inductively coupled plasma mass spectrometry and a range of titration, selective ion electrode and gravimetric techniques all of which were suitable for water quality analysis.

Analytical techniques used for solutions were usually those listed as the various protocols in the American Public Health Association Manuals. All analyses were undertaken in the NATA accredited laboratories of Australian Laboratory Services (ALS), Stafford Brisbane or the internationally recognized laboratories of the Advanced Analytical Centre, James Cook University, Townsville.

The air-dried solids were prepared for analysis using X-ray powder diffraction techniques in the laboratories of the Advanced Analytical Centre. This preparation consisted of gentle grinding to an approximate particle size of 4-20 μm. The resultant powder was then smear mounted on a glass slide or loaded into a sample cavity mount. The mounting technique used being partially dependent on the amount of crystalline solid available.

For X-ray diffraction analysis the experimental conditions used were a Siemens (now Brucker) D5000 diffractometer using Copper K-alpha radiation with a post diffraction graphite crystal monochromator. All diffraction runs were over the angular range 5 to 65 degrees 2-theta, this range from past experience being appropriate for the identification of the crystalline phases likely to be present. Identification of the crystalline phases was accomplished by comparison with standard pattern present in the databases of the Joint Committee of Powder Diffraction Standards.

Some semi-quantitative X-ray diffraction analyses of the solid phases present was undertaken using established techniques including calibrated peak area techniques and the Reitveld based techniques used in the SIROQUANT program. Chemical speciation modeling was undertaken for 12 starting and final solutions using either or both the WATEQF4 and PHREEQC sets of programs.

Where possible all analytical techniques corresponded to APHA Water Quality analytical protocols.
All sea water used in the experiments had compositions consistent with those given in Table 5.
All other water used was atmospherically equilibrated distilled water. De-ionised water was not used as the as the de-ionising resins even at very low concentrations, are known to inhibit some crystallisation processes.

### Calcium Carbonate Production

Recognised by X-Ray Diffraction lines at:

| | | |
|---|---|---|
| 0.30359 nm | Intensity | 100 |
| 0.20953 nm | Intensity | 20 |
| 0.22852 nm | Intensity | 15 |

Assumption:

Assume 1 litre seawater at 35‰ (ppt) contains:
400 mg/Kg (ppm) Calcium (total)
120 mg/Kg (ppm) Bicarbonate (total)

| | | | |
|---|---|---|---|
| | YIELD | YIELD | Equivalent |
| Precipitation technique used in experiment. | CaCO₃ | CaCO₃ | CO₂ |

| | | |
|---|---|---|
| Seawater at equilibrium with | 8.2 g/200 L | 41 mg/L = 11 mg CO₂/L |
| atmosphere | | |
| By simple aeration: (pCO₂ = 3.4 × | 1.7 g/200 L | 8.5 mg/L = 3.74 mg CO₂/L |
| 10⁻⁴ atm) *SCENARIO 1 | | |
| Aeration + Evaporation: | 42.8 g/200 L | 214 mg/L = 94.1 mg CO₂/L |
| Aeration + Evaporation + Ca(OH)₂ | 64 g/200 L | 320 mg/L = 140.7 mg CO₂/L |
| *SCENARIO 2 | | |
| Water in contact with aragonite | 0.41 g/200 L | 205 mg/L = 0.9 mg CO₂/L |
| *SCENARIO 3 | | |
| Water in contact with aragonite + water | 2 g/200 L | 10 mg/L = 4.4 mg CO₂/L |
| charge (no air) | | |
| Water in contact with aragonite | 24 g/200 L | 120 mg/L = 53 mg CO₂/L |
| (ρCO₂ = 1 atmosphere) | | |
| Using Ca(OH)₂ + (KHCO₃) − KHCO₃ | 256 g/200 L | 1280 mg/L = 562.8 CO₂/L |
| totally dissolved.*SCENARIO 4 | | |

Of the above, four scenarios were subjected to detailed testing, namely scenarios 1 to 4:

| Scenario 1 | Scenario 2 | Scenario 3 | Scenario 4 |
|---|---|---|---|
| 1.7 g CaCO₃/200 L | 64 g CaCO₃/200 L | 41 mg CaCO₃/200 L | 256 g CaCO₃/200 L |
| | (adding Ca(0H)₂) | | (adding Ca(0H)₂) and |
| | | | KHCO₃. |

| | |
|---|---|
| Scenario 1 | 1.7 g CaCO₃/200 L, 0.0085 g/L CaCO₃, 0.005181 g/L HCO₃_{^{−}}, 0.003737 g/LCO₂ |
| Scenario 2 | 64 g CaCO₃/200 L, 0.320 g/L CaCO₃, 0.1951 g/L HCO₃_{^{−}}, 0.140737 g/LCO₂ |
| Scenario 3 | 0.41 mg CaCO₃/200 L, 0.0205 g/L CaCO₃, 0.0125 g/L HCO₃_{^{−}}, 0.0090 g/LCO₂ |
| Scenario 4 | 256 g CaCO₃/200 L, 1.28 g/L CaCO₃, 0.7808 g/L HCO₃_{^{−}}, 0.5632 g/LCO₂ |

Given 120 ppm HCO₃ in input sea water —
HCO₃-used in precipitating CaCO₃ HCO₃— remaining in XRD Identification of sea water after 24 products hours and removal of solid (ppm)

| | | | |
|---|---|---|---|
| Scenario 1 | 5.181 ppm HCO₃_{^{−}} | 125 | Calcite |
| Scenario 2 | 195.1 ppm HCO₃_{^{−}} | 115 | Calcite |
| Scenario 3 | 25 ppm HCO₃_{^{−}} | 117 | Calcite |
| Scenario 4 | 780 ppm HCO₃_{^{−}} | N/A HCO₃⁻ added | Calcite 80% |
| | | | Aragonite 10% |
| | | | NaHCO₃ |
| | | | (Nahcolite) |
| | | | 10% |

Aragonite recognised by X-Ray Diffraction lines at:

| | | |
|---|---|---|
| 0.3398 nm | Intensity | 100 |
| 0.1978 nm | Intensity | 30 |
| 0.3275 nm | Intensity | 70 |

Nahcolite by X-Ray Diffraction lines at:

| | | |
|---|---|---|
| 0.2971 nm | Intensity | 100 |
| 0.2604 nm | Intensity | 70 |
| 0.3084 nm | Intensity | 30 |

Quantification by peak area method and SIROQUANT.

### Magnesite/Dolomite

Magnesite recognised by X-Ray Diffraction lines at:

| | | |
|---|---|---|
| 0.2745 nm | Intensity | 100 |
| 0.2104 nm | Intensity | 60 |
| 0.1703 nm | Intensity | 20 |

Dolomite recognised by X-Ray Diffraction lines at:

| | | |
|---|---|---|
| 0.2884 nm | Intensity | 100 |
| 0.1787 nm | Intensity | 50 |
| 0.2190 nm | Intensity | 60 |

Assumption is that:

1 litre seawater at 35‰ (ppt) contains:
400 ppm (mg/Kg) Calcium (total)
1300 ppm (mg/Kg) Magnesium (total)
120 ppm (mg/Kg) Bicarbonate (total)
Molal ratio Ca:Mg 1:5.345

| | YIELD | YIELD | EQUIVALENT CO₂ | |
|---|---|---|---|---|
| Scenario 1M | | | | |
| Simple aeration | 1.45 g/ | 7.2 mg/L | 3.75 | mg CO₂/L Mag |
| pCO₂ = 3.4 × 10⁻⁴ atm | 200 L | Magnesite | | |
| Bovine anhydrase as | | | | |
| nucleating agent | | | | |
| Scenario 2M1 | | | | |
| Aeration + Evaporation + | 59 g/200 L | 295 mg/L | 141 | mg CO₂/L |
| CaCl_{2 SOLN} | | Disordered Dolomite | | |
| Scenario 2M2 | | | | |
| Aeration + Evaporation + | 53.8 g/ | 270 mg/L | 139 | mg CO₂/L |
| MgCl_{2 SOLN} | 200 L | Magnesite | | |
| Scenario 3M1 | | | | |
| Water in contact with | 1.01 g/200 L | 5.03 mg/L Magnesite | 2.63 | mg CO₂/L |
| Magnesite | | | | |
| Scenario 3M2 | | | | |
| Water in contact with Dolomite | 1.11 g/ | 5.56 mg/L | 2.65 | mg CO₂/L |
| | 200 L | Disordered Dolomite | | |
| Scenario 4M1 | | | | |
| Using CaCl_{2 SOLN} + KHCO_{3 SOLN} + | 235 g/ | 1180 mg/L | ~562 | mg/L CO₂ |
| bovine anhydrase as | 200L | Disordered Dolomite + | | |
| nucleating agent | | Nahcolite + Trona | | |
| Using MgCl_{2 SOLN} + KHCO_{3 SOLN} + | 216 g/ | 1078 mg/L | ~563 | mg/L CO₂ |
| bovine anhydrase as | 200 L | Magnesite + Naticolite + | | |
| nucleating agent | | Trona | | |

Given 120 ppm HCO₃— sea water:

| | | HCO₃_{^{−}} remaining in | |
|---|---|---|---|
| | | sea water after 24 | |
| | HCO₃_{^{−}} used in | hours and removal of | XRD Identification of |
| SCENARIO | precipitating product | solid ppm | product |
| 1 | 5.20 ppm | 120 | Magnesite |
| | | | (Trace Calcite) |
| 2M1 | 199 ppm | 123 | Disordered Dolomite 80% |
| | | | Calcite 20% |
| 2M2 | 193 ppm | 116 | Magnesite |
| | | | (Trace Calcite) |
| 3M1 | 36 ppm | 125 | Magnesite |
| | | | (Trace Calcite) |
| 3M2 | 38 ppm | 118 | Dolomite 90% |
| | | | Calcite 10% |
| 4M1 | 781 ppm | N/A | Dolomite 80% Nahcolite |
| | | HCO₃_{^{−}} Added | 20% |
| | | | Trona-trace |
| 4M2 | 778 ppm | N/A | Magnesite 80% |
| | | HCO₃_{^{−}} Added | Nahcolite 20% |
| | | | Trona-trace |

Nahcolite recognised by X-Ray Diffraction lines at:

| | | |
|---|---|---|
| 0.2972 nm | Intensity | 100 |
| 0.2603 nm | Intensity | 70 |
| 0.3084 nm | Intensity | 35 |

Trona recognised by X-Ray Diffraction lines at:

| | | |
|---|---|---|
| 0.2648 nm | Intensity | 100 |
| 0.3072 nm | Intensity | 80 |
| 0.4892 nm | Intensity | 35 |

In runs 4M1 and 4M2, more pure NaHCO₃ was crystallised from either Dolomite or Magnesite mixtures by treating the separated solid mixture with distilled or tap water. The Dolomite or Magnesite being insoluble do not dissolve, whereas the NaHCO₃, being appreciably more soluble, dissolves. It is recrystallised from the solution by evaporation.

1. A process for sequestration of carbon dioxide, including the steps of:
adding a halide of a divalent cation to a body of supersaturated carbonate-containing brine which is in contact with a CO₂-containing atmosphere so as to cause the halide of the divalent cation to form a carbonate of the divalent cation, said carbonate having low solubility; and
causing the carbonate of the divalent cation to precipitate from the body of carbonate containing brine.

2. The process of claim 1 wherein the step of causing the carbonate of the divalent cation to precipitate comprises adding a nucleating agent to the brine, wherein the nucleating agent is capable of facilitating the formation of calcite and/or dolomite and/or magnesite; and causing calcite and/or dolomite and/or magnesite to precipitate from the brine.

3. The process of claim 2 wherein the nucleating agent is selected from the group consisting of limestone, calcite, dolomite, vaterite, clay minerals, purified bovine carbonic anhydrase, purified human carbonic anhydrase, calcium oxalate, sodium carbonate, porphyrin amphiphiles, magnetic fields, proteins, sodium oleate and a range of natural poorly defined soap compounds including sapo animals (curd soap), sap durus (hard shap) and sap mollis (soft soap).

4. The process of claim 1 further including the steps of collecting and disposing of the carbonate of the divalent cation precipitated.

5. The process of claim 1 wherein the brine is supersaturated with respect to carbonates of divalent cations including calcium and/or magnesium carbonate.

6. The process of claim 1 comprising the step of providing the halide of the divalent cation.

7. The process of claim 6 wherein the step of providing the halide of the divalent cation comprises:
(a) reacting a carbonate, oxide or hydroxide of the divalent cation with carbon dioxide and water and/or with a species resulting from the dissolution of carbon dioxide in water, to form a hydrogen carbonate of the divalent cation; and
(b) exchanging the divalent cation of the hydrogen carbonate of the divalent cation formed in (a), using an ion exchange medium, for the monovalent cation to produce a solution of a hydrogen carbonate of the monovalent cation;
wherein said carbonate, oxide or hydroxide of the divalent cation has a low solubility in water.

8. The process of claim 7 additionally comprising:
(c) regenerating the ion exchange medium with a halide of the monovalent cation or with a hydrohalic acid to produce a halide of the divalent cation.

9. The process of claim 7 wherein the carbonate, oxide or hydroxide of the divalent cation has a solubility product (Ksp) value at ambient temperature and pressure, of less than about 1×10⁻⁶.

10. The process of claim 7 wherein the divalent cation is selected from the group consisting of calcium, magnesium, strontium, barium, lead, cadmium, zinc, cobalt, nickel, manganese, iron, the transition metals, and any combination thereof.

11. The process of claim 7 wherein the carbon dioxide for step (a) is obtained from a carbon dioxide containing gas and/or from the atmosphere.

12. The process of claim 11 additionally comprising removing particles from the carbon dioxide containing gas.

13. The process of claim 7 additionally comprising the preliminary step of generating at least part of the carbon dioxide for step (a).

14. The process of claim 7 further including the step of reacting the hydrogen carbonate of the monovalent cation formed in step (b) with a sulphate of a divalent cation to produce a carbonate of the divalent cation and a sulphate of the monovalent cation.

15. The process of claim 7 also including the step of recycling any carbon dioxide released from subsequent step(s) to step (a).

16. The process of claim 7 wherein step (a) is performed within an enclosed chamber.

17. The process of claim 16 wherein the enclosed chamber contains a carbon dioxide containing atmosphere.

18. The process of claim 17 wherein the carbon dioxide containing atmosphere is at a temperature of between about 5 and about 60° C.

19. The process of claim 17 wherein the carbon dioxide containing atmosphere is at a total pressure of from about 0.0003 atmosphere to about 10 atmospheres.

20. The process of claim 17 wherein the carbon dioxide containing atmosphere has a CO₂ partial pressure ranging from about 0.0003 to about 0.5 atmospheres.

21. The process of claim 17 wherein the carbon dioxide containing atmosphere has a carbon dioxide content ranging from about 300 parts per million (i.e. about 0.03 vol %) to about 50 vol %.

22. The process of claim 7 wherein the carbonate, oxide or hydroxide of the divalent cation is selected from the group consisting of calcite, aragonite, dolomite, huntite, limestone, vaterite, magnesite, magnesium oxide, barringtonite, nesquehonite, lansfordite artinite, hydromagnesite, dypingite, and 4MgCO₃.Mg(OH)₂.8H₂O.

23. The process of claim 7 wherein the carbonate, oxide or hydroxide of the divalent cation is at least partially calcined.

24. The process of claim 7 wherein the carbonate, oxide or hydroxide of the divalent cation is in the form of an anhydrous powder or an aqueous slurry or a paste.

25. The process of claim 7 wherein step (a) comprises preparing an aqueous slurry from the carbonate, oxide or hydroxide of the divalent cation and water, and mixing the slurry with an aqueous solution of carbon dioxide or a derivative thereof.

26. The process of claim 7 wherein the hydrogen carbonate of the divalent cation is in an aqueous solution and the process comprises controlling the pH of said aqueous solution so that the final pH thereof falls within a range of from about 7.5 to about 9.0.

27. The process of claim 7 wherein the carbonate, oxide or hydroxide of the divalent cation is contacted with a quantity of the carbon dioxide and/or species resulting from the dissolution of the carbon dioxide in water, which exceeds a stoichiometric quantity by from about 0% to about 20%.

28. The process of claim 7 wherein the monovalent cation is sodium or potassium.

29. The process of claim 8 wherein the halide is selected from the group consisting of fluoride, chloride, bromide, iodide, and a mixture of any two or more thereof.

30. The process of claim 7 additionally comprising:
(d) recovering said hydrogen carbonate of the monovalent cation from the solution of said hydrogen carbonate of the monovalent cation by evaporating water from said solution.

31. An apparatus for the sequestration of carbon dioxide, comprising:
a contactor for contacting a halide of a divalent cation to a body of supersaturated carbonate-containing brine which is in contact with a carbon dioxide containing gas so as to cause the halide of the divalent cation to form a carbonate of a divalent cation, which precipitates from the body of carbonate-containing brine, said carbonate having low solubility; and
a separator for separating the carbonate of the divalent cation from the body of carbonate-containing brine.

32. The apparatus of claim 31 additionally comprising a nucleator for adding a nucleating agent to the brine, so as to cause calcite and/or dolomite and/or magnesite and/or sodium carbonate phases to precipitate from the brine.

33. The apparatus of claim 31 additionally comprising an evaporator for evaporating water from the brine.

34. The apparatus of claim 33 wherein the evaporator comprises a canal.

35. The apparatus of claim 31, comprising:
(a) a bicarbonator reactor for reacting a carbonate of a divalent cation with the carbon dioxide and water and/or with a species resulting from the dissolution of the carbon dioxide in water, to form a hydrogen carbonate of the divalent cation wherein said divalent cation is capable of forming a carbonate that has a low solubility in water; and
(b) an ion exchange medium for exchanging the divalent cation of the hydrogen carbonate formed in the bicarbonator reactor for a monovalent cation to produce a hydrogen carbonate of the monovalent cation; and
(c) an ion exchange medium regenerator for regenerating the ion exchange medium with halide of the monovalent halide or with a hydrohalic acid to produce a halide of the divalent cation.

36. The apparatus of claim 35 wherein said bicarbonator reactor is adapted to be operated at a pressure of from about 0.0003 atm to about 10 atm.

37. The apparatus of claim 35 comprising an entrance port for admitting a carbon dioxide containing gas.

38. The apparatus of claim 37 additionally comprising a particle remover for removing particles from the carbon dioxide containing gas.

39. The apparatus of claim 35 wherein the bicarbonate reactor comprises means for controlling the pressure of the bicarbonator reactor between about 0.0003 atm and about 10 atm.
